(19) United States
(12) Patent Application Publication
(10) Pub. No.: US 2026/0269244 A1
(43) Pub. Date: Sep. 10, 2026

(54) PRE-INTERCALATED TUNNEL-PHASE V2O5 AS A BATTERY CATHODE MATERIAL

(71) Applicant: THE TEXAS A&M UNIVERSITY SYSTEM, COLLEGE STATION, TX (US)

(72) Inventors: SARBAJIT BANERJEE, COLLEGE STATION, TX (US); YUTING LUO, URBANA, IL (US); JOSEPH V. HANDY, FOREST GROVE, OR (US)

(21) Appl. No.: 19/116,429

(22) PCT Filed: Sep. 28, 2023
(86) PCT No.: PCT/US2023/033969

§ 371 Date: Mar. 28, 2025

Related U.S. Application Data
(60) Provisional application No. 63/410,707, filed on Sep. 28, 2022.

(51) Int. Cl. H01M 4/58; H01M 4/02; H01M 4/04; H01M 10/0525; H01M 10/054

(52) U.S. Cl. CPC H01M 4/5825; H01M 4/0471; H01M 10/0525; H01M 10/054; H01M 2004/028

(57) ABSTRACT

The subject invention pertains to design of strategies that enable the more effective utilization of active intercalation materials in the production of lithium ion batteries. Na- and K-ion intercalation “props” open the 1D tunnel, reduces electrostatic repulsions between inserted Li-ions, and entirely modifies diffusion pathways, enabling orders of magnitude higher Li-ion diffusivities and accessing higher capacities. The subject invention provides materials and batteries comprising the materials produced via the methods disclosed within this application.

### CROSS-REFERENCE TO RELATED APPLICATION

This application claims the benefit of U.S. Provisional Application Ser. No. 63/410,707, filed Sep. 28, 2022, the disclosure of which is hereby incorporated by reference in its entirety, including all figures, tables and amino acid or nucleic acid sequences.

### STATEMENT REGARDING FEDERALLY SPONSORED RESEARCH

This invention was made with government support under STTR Phase I awarded by the National Science Foundation and by the Department of Energy. The government has certain rights in the invention.

### BACKGROUND OF THE INVENTION

Lithium-ion batteries (LIBs) have a crucial role to play in the energy transition, from enabling electromobility to managing renewable energy curtailment and addressing the myriad challenges of an entirely reimagined electric grid.¹⁻⁴ However, state-of-the-art devices have reached only about 25% of their possible theoretical capacity.^{3,5} Unlocking the remaining capacity and mitigating common degradation mechanisms that limit energy storage architectures from realizing their full potential requires the design of materials that dynamically adapt to the reversible insertion of Li-ions across multiple length scales with minimal distortions of their crystal lattice, particle geometry, and overall electrode architecture.⁶⁻¹¹ Limitations in electrochemical performance as well as supply chain challenges have rendered cathode materials a critical bottleneck to the development of LIBs.¹²⁻¹⁴ An important lever for realizing the full potential of cathode materials is the idea of pre-intercalation wherein (typically) alkali- or alkaline-earth cations occupy specific interstitial sites, thereby expanding the galleries between layered materials or propping open 3D structures.¹⁵⁻¹⁷ In this work, we directly examine the role of alkali-metal-ion pre-intercalation by comparing lithiation/delithiation mechanisms in ζ-V₂O₅, a 1D tunnel-structured polymorph of V₂O₅, upon pre-intercalation with Na- and K-ions. Specifically, we have examined insertion electrodes with the same lattice framework (ζ-V₂O₅) comprising particles with similar geometries prepared according to the same electrode specifications that differ only in terms of their pre-intercalated ion. By mapping the dynamical evolution of lithiation-induced structural perturbations using synchrotron-based operando X-ray diffraction (XRD) measurements along with unprecedented high-resolution single-crystal X-ray diffraction imaging of topochemical lithiation of macroscopic crystals of β-NaₓV₂O₅ and by correlating the observed structure evolution to electrochemical performance, we have deciphered the effect of pre-intercalation on crystal lattice dynamics and diffusion pathways traversed by Li-ions.

As a result of its multiple accessible redox couples and limited proclivity for oxygen evolution, V₂O₅ represents an attractive intercalation host and was indeed an early candidate cathode explored by Whittingham and others.¹⁸⁻²¹ Moreover, vanadium boasts globally-diverse supply chains with major producers spread across Asia, Africa, and the Americas; and considerable primary capacity is poised to come on line within the next decade across Australia, Central Asia, and Canada.²² Despite these beneficial features and appealing economic prospects for vanadium production, lithiation of the thermodynamically stable layered orthorhombic polymorph of V₂O₅ triggers a series of increasingly distortive intercalation-induced structural phase transformations, which are ultimately irreversible beyond x>1 in LiₓV₂O₅.²³ However, to overcome challenges tied to intercalation-induced structural transformations, V₂O₅ provides a remarkable platform for decoupling composition from extended atomic structure by accessing a plethora of metastable polymorphs across its “rugged” energy landscape.²⁴⁻²⁶

In order to address the challenges of phase heterogeneity, diffusion limitations at phase boundaries, and stress accumulation,^{9,26-28} we have identified a 1D tunnel-structured 2-V₂O₅ polymorph as ideal for accommodating Li-ions through a distinctive lithiation mechanism involving cation reordering instead of phase transformations.^{25,26,29} The rigid 1D framework of ζ-V₂O₅ polymorph alleviates phase heterogeneity, enabling excellent cycling stability and improved rate capability.³⁰ As such, with a view towards developing generalizable mechanistic understanding, we explore the effects of pre-intercalation on this 1D polymorph of V₂O₅.^{26,31}

Chemical pre-intercalation has been used a means of “pillaring”, expanding interlayer spacing in layered structures, in order to increase accessible capacity and diffusivity.^{16,32-35} For instance, Pomerantseva et al. have reported δ-AₓV₂O₅ (A=Li, Na, K, Mg, Ca) with expanded interlayer spacing, which shows improved discharge/charge capacity.³³ Messina et al. and Pereira-Ramos et al. have reported electrochemical lithium intercalation in Na_{0.33}V₂O₅ bronze.³⁶⁻³⁸ However, mechanistic understanding of how pre-intercalation affects structure dynamics and diffusion pathways remains unexplored. In this work, our ability to grow single crystals of β-AₓV₂O₅ (A=Na and K) and to topochemically lithiate large single crystals has enabled an atomic-resolution view of pre-intercalation-induced modifications to diffusion pathways. Pre-intercalated β-Na_{0.25}V₂O₅ and β-K_{0.27}V₂O₅ have further been examined by operando synchrotron X-ray powder diffraction (XRD) to examine cation reordering across several distinctive regimes. The pre-intercalation-derived altered structural dynamics and diffusion pathways are shown to correlate with improved discharge/charge capacities and substantially enhanced Li-ion diffusivities. The results provide generalizable mechanistic understanding of the role of pre-intercalation in decreasing the magnitude of lattice modulation and affording alternative diffusion pathways.

### BRIEF SUMMARY OF THE INVENTION

An embodiment of the disclosure is a method of making preintercalated β-NaₓV₂O₅ and β-K_{y}V₂O₅, where x is about 0.20 to about 0.34 and y is about 0.20 to about 0.33 comprising: reacting V₂O₅ and oxalic acid in water and heating the mixture to a temperature of between about 60° C. and about 100° C., preferably between about 70° C. and about 90° C., or at a temperature of about 80° C. or at a temperature of 80° C. and adding sodium nitrate or potassium nitrate to the solution. The mixtures provided herein can be stirred and maintained under open air until free water is evaporated and a powder is obtained. The powder can be ground, using for example a mortar and pestle, and annealed under ambient conditions in a muffle furnace (for example at a temperature of about 450° C.) for a period of about 6 hours. Materials formed by this process can then be formed into components of a battery (i.e., as a cathode) and intercalated with appropriate ions (e.g., lithium ions).

As sketched in FIG. 6, the thermodynamic minimum phase α-V₂O₅ can be used to synthesize a variety of ternary and quaternary bronzes with diverse layered and tunnel-like extended V₂O₅ connectivities, as a function of guest cation(s) M and stoichiometry x and y for MₓV₂O₅ or M¹ₓM²_{y}V₂O₅. Topochemical treatment can then be used to remove these guest cations and kinetically trap extended V₂O₅ frameworks outside of thermodynamic equilibrium, giving rise to altogether new metastable phases of V₂O₅ that serve as host structures for an extremely diverse palette of guest cations of species. By effectively decoupling composition from structure, V₂O₅ allows for precise manipulation of ion diffusion pathways as abstracted graphically in FIG. 6 and will be discussed in subsequent sections.

### BRIEF DESCRIPTION OF THE DRAWINGS

The patent or application file contains at least one drawing executed in color. Copies of this patent or patent application publication, with color drawing(s), will be provided by the Office upon request and payment of the necessary fee.

FIGS. 1A-1J: Structural and morphological characterization. FIGS. 1A-1B: Refined single-crystal structures of β-Na_{0.32}V₂O₅ (FIG. 1A) and β-K_{0.22}V₂O₅ (FIG. 1B) viewed down the b-axis. Color key: Na=yellow, K=purple, blue polyhedra=VO₆/VO₅. All thermal ellipsoids shown at 90% probability, unit cell boundaries indicated by a dashed line. FIG. 1C: Single-crystal structure of empty ζ-V₂O₅ viewed down the b-axis, with vacant β- (unit cell multiplicity 4), and β′- (multiplicity 4), and C-sites (multiplicity 2), indicated by light gray, dark gray, and blue dashed circles, respectively. Orange polyhedra=VO₆/VO₅, unit cell boundaries indicated by a dashed line. FIGS. 1D-1F: Perspective views of 7-coordinate β-site occupied by Na⁺ (FIG. 1D), K⁺ (FIG. 1E), and 5-coordinate β′-site occupied by Li⁺ (FIG. 1F) within the V₂O₅ tunnel, with dashed lines indicating the 7-coordinate Shannon radii of Na (1.26 Å), K (1.60 Å), and Li (0.90 Å). Thermal ellipsoids shown at 60% probability. FIG. 1G: Perspective view of the ζ-V₂O₅ tunnel with 7-coordinate β-, 5-coordinate β′-, and 2-coordinate C-sites indicated by light gray, dark gray, and blue spheres, respectively. Scanning electron microscopy images of β-Na_{0.25} V₂O₅ (FIG. 1H) and β-K_{0.27}V₂O₅ (FIG. 1I). FIG. 1J: Schematic illustration of tunnel expansion induced by Na⁺/K⁺ chemically pre-intercalation.

FIGS. 2A-2I: Electrochemical performance characterization for β-Na_{0.25}V₂O₅ and β-K_{0.27}V₂O₅. Cyclic voltammograms acquired at a scan rate of 0.1 mV/s for initial three cycles between 2-4 V for β-Na_{0.25}V₂O₅ (FIG. 2A) and β-K_{0.27}V₂O₅ (FIG. 2D). Galvanostatic discharge/charge profiles acquired at a C-rate of C/20 for three initial cycles between 2-4V of β-Na_{0.25} V₂O₅ (FIG. 2B) and β-K_{0.27}V₂O₅ (FIG. 2E). Galvanostatic discharge/charge profiles cycling at a C-rate of C/2 three cycles between 2-4 V for β-Na_{0.25}V₂O₅ (FIG. 2C) and β-K_{0.27}V₂O₅ (FIG. 2F). Cycling performance for ζ-V₂O₅ (FIG. 2G), β-Na_{0.25} V₂O₅ (FIG. 2H) and β-K_{0.27}V₂O₅ (FIG. 2I). Cells were cycled at a C-rate of C/20 between 2.2-3.7 V for first three cycles for electrode-electrolyte interface stabilization, followed by cycling at C-rate of C/5 for 100 cycles. Additional cycling datasets acquired for ζ-V₂O₅, β-Na_{0.25}V₂O₅, and β-K_{0.27}V₂O₅ are presented in FIGS. 9A-9C.

FIGS. 3A-3E. Single-crystal X-ray diffraction mapping of lithium-ion diffusion in pre-intercalated β-NaₓV₂O₅ and β-KₓV₂O₅. View of the extended P21/m structure of topochemically lithiated β′-Li_{0.33}/β-Na_{0.32}V₂O₅ (FIG. 3A) and C2/m structure of topochemically lithiated β′-Li_{0.23}/β-K_{0.22} V₂O₅ (FIG. 3B) as refined from single-crystal X-ray diffraction, viewed down the b-axis. Color key: Yellow=Na, Purple=K, Green=Li, Blue polyhedra=VO₆/VO₅. All thermal ellipsoids shown at 90% probability, unit cell boundaries indicated by a dashed line. Perspective view of site-filling in the tunnel structure of β-Na_{0.32} V₂O₅ before (FIG. 3C) and after (FIG. 3D) topochemical lithiation with 0.02 M n-BuLi, showing the reordering of Nations (yellow) from random distribution in all β-sites to only half of β-sites on one side of the tunnel, in order to accommodate Li⁺ ions (green) in half of β′-sites on the opposite side. Partial atomic occupancy as obtained from single-crystal refinement is indicated by the partial filling of spheres, and by site labels. (FIG. 3E) View of Li-ion diffusion through an “empty” ζ-V₂O₅ tunnel, as viewed in cutaway down the a-axis, showing the unrestricted access to β-, β′-, and C-sites mirrored across the center of the tunnel in contrast to the lopsided filling motif obtained by lithiation of pre-intercalated β-NaₓV₂O₅. Available sites are indicated by colorless spheres, sites filled by Li⁺ along a hypothetical diffusion pathway are colored green, and the pathway is indicated by a dashed arrow.

FIGS. 4A-4J. Structural evolution characterized by operando synchrotron XRD. Galvanostatic discharge/charge profiles acquired during operando XRD measurements at a C-rate of C/20 for the first cycle between 2-4 V for (FIG. 4A) β-Na_{0.25}V₂O₅ and (FIG. 4F) β-K_{0.27}V₂O₅. Operando XRD contour plots of β-Na_{0.25}V₂O₅ (FIG. 4B) and β-K_{0.27}V₂O₅ (FIG. 4G), which correspond to discharge/charge processes in FIG. 4A and FIG. 4F. Corresponding magnified view of operando XRD waterfall plots in the range of 2θ=1.3-2.1° during discharge/charge of β-Na_{0.25}V₂O₅ (FIG. 4C) and β-K_{0.27}V₂O₅ (FIG. 4H). Lattice parameters a (blue triangles), b (red triangles), c (green triangles) and β angle (black circles) of β-Na_{0.25} V₂O₅ (FIG. 4D) and β-K_{0.27}V₂O₅ (FIG. 4I). Unit cell volume comparison in corresponding regimes of β-Na_{0.25}V₂O₅ (FIG. 4E) and β-K_{0.27}V₂O₅ (FIG. 4J). A, B, C and D correspond to intercalation regimes for β-Na_{0.25} V₂O₅; A′, β′, C′ and D′ correspond to intercalation regimes for β-K_{0.27}V₂O₅, which are listed in Table 1.

FIG. 5. Migration barriers in pre-intercalated compounds. Relative energy barrier representations calculated for Li-ion migration within pre-intercalated β-NaₓV₂O₅ and β-KₓV₂O₅. Blue and red curves depict Li migration pathways and barriers in pre-intercalated β-NaₓV₂O₅ and β-KₓV₂O₅, respectively. Li, Na, K, O and V atoms are represented by green, yellow, purple, red and dark blue spheres, respectively.

FIG. 6. Synthetic scheme and crystallographic relationship between thermodynamic and metastable phases of V₂O₅. Beginning with thermodynamic α-V₂O₅, the introduction of cations of varying species and stoichiometry allows for a variety of ternary and quaternary bronzes with diverse layered and tunnel-like connectivity of the extended V—O lattice to be synthesized. Subsequent removal of these cations via topochemical methods kinetically traps the lattice and gives access to new metastable polymorphs of V₂O₅ (highlighted with a yellow glow). In turn, new guest cations can then be inserted to these “empty” polymorphs to access structures with the same extended V₂O₅ lattice but accommodating guest cations in sites or with stoichiometries outside of thermodynamic minimum for a given composition, giving rise to an extremely broad palette of structures outside of thermodynamic equilibrium. Thermodynamic phases are indicated with a solid outline; metastable phases are indicated with dashed outlines; fully-oxidized “empty” polymorphs are highlighted with a yellow glow.

FIGS. 7A-7D. Structural characterization of pre-intercalated compounds. Rietveld refinement of the X-ray diffraction patterns of β-Na_{0.25} V₂O₅ (FIG. 7A) and β-K_{0.27}V₂O₅ (FIG. 7C). The data are shown as black circles, and the result of the refinement is plotted as a red solid line. The background is shown as blue solid line and the difference (observed-calculated) is shown as green solid line. The vertical red bars show the Bragg peak positions for β-Na_{0.25}V₂O₅ phase in FIG. 7A and for β-K_{0.27}V₂O₅ phase in FIG. 7C, respectively. Asterisks denote reflections from carbon materials used in electrode assembly. Crystal structures of β-Na_{0.25}V₂O₅ (FIG. 7B) and β-K_{0.27}V₂O₅ (FIG. 7D) which are obtained from Rietveld refinement (FIGS. 7A and 7C). Blue, red, yellow and purple spheres represent vanadium, oxygen, sodium and potassium atoms, respectively. Blue polyhedrons, yellow polyhedrons and purple polyhedrons represent VOₓ, NaO_{y}, and KO_{z} units.

FIGS. 8A-8F. Additional Coin Cell Cycling Performance of Na_{0.25}V₂O₅ and β-K_{0.27}V₂O₅ Positive Electrodes. Cycling performance of β-Na_{0.25}V₂O₅ (FIGS. 8A-8C) and β-K_{0.27}V₂O₅ (FIGS. 8D-8F) between 2.0-4.0 V at a C-rate of C/2 for 100 cycles for three separate coin cells.

FIGS. 9A-9C. Additional Coin Cell Cycling Performance of Na_{0.25} V₂O₅ and β-K_{0.27} V₂O₅ Positive Electrodes Contrasted with ζ-V₂O₅. Additional cycling performance for ζ-V₂O₅ (FIG. 9A), β-Na_{0.25}V₂O₅ (FIG. 9B) and β-K_{0.27}V₂O₅ (FIG. 9C). Cells were cycled between 2.2-3.7 V at a C-rate of C/20 for first three cycles for electrode-electrolyte interface stabilization and followed by cycling at C-rate of C/5 for 100 cycles.

FIGS. 10A-10G: Li-ion diffusivity investigation of ζ-V₂O₅, β-Na_{0.25}V₂O₅ and β-K_{0.27}V₂O₅. Cyclic voltammograms measured at scan rates of 0.1, 0.2, 0.3, 0.5 and 1 mV/s between 2-4 V for ζ-V₂O₅ (FIG. 10A), β-Na_{0.25}V₂O₅ (FIG. 10B) and β-K_{0.27}V₂O₅ (FIG. 10C). Corresponding plots of peak current (Iₚ) versus square root of scan rates (v^{1/2}) of ζ-V₂O₅ (FIG. 10D), β-Na_{0.25} V₂O₅ (FIG. 10E) and β-K_{0.27}V₂O₅ (FIG. 10F). FIG. 10G: Calculated Li-ion diffusion coefficients of ζ-V₂O₅, β-Na_{0.25} V₂O₅ and β-K_{0.27}V₂O₅ in different intercalation regimes based on Randles-Sevcik analysis. Black, blue and red markers represent ζ-V₂O₅, β-Na_{0.25}V₂O₅ and β-K_{0.27}V₂O₅, respectively. Solid marker with solid line represents Li-ion diffusivity in reduction process; empty marker with dashed line represents Li-ion diffusivity in oxidation process.

FIG. 11. Site-Selective Li-Ion Insertion in β-KₓV₂O₅. Perspective view of site-filling in the refined tunnel structure of β-K_{0.22}/β′-Li_{0.23} V₂O₅ after topochemical lithiation with 0.033M n-buLi, showing the site preference of K⁺ (purple) for 7-coordinated β-sites and Li⁺ (green) for 5-coordinated β′-sites. Partial occupancy of the sites is labeled and also indicated with partially-colored spheres.

FIG. 12. Li-ion migration barriers in ζ-V₂O₅ and β-LiₓV₂O₅. Relative energy barrier representations calculated for Li-ion migration in ζ-V₂O₅ and pre-intercalated β-LiₓV₂O₅. Blue and red curves depict Li migration pathways and barriers in ζ-V₂O₅ and pre-intercalated β-LiₓV₂O₅ structures, respectively. Li, O, and V atoms are represented by green, red, and dark blue spheres, respectively.

FIGS. 13A-13B. Electronic structure implications of pre-intercalation. Density of states plot calculated for lithiated structures of (FIG. 13A) β-Na_{0.25}V₂O₅ and (FIG. 13B) β-K_{0.27}V₂O₅. In comparison to ζ-V₂O₅ (FIGS. 14A-14B), vanadium reduction is reflected by the appearance of states at the bottom of the conduction band and new filled V 3d-O 2p (polaronic) states at the top of the valence band.

FIGS. 14A-14B. Electronic structure implications of lithiation of ζ-V₂O₅. Density of states plot calculated for lithiated structures of (FIG. 14A) β-LiₓV₂O₅ and (FIG. 14B) “empty” ζ-V₂O₅. Lithiation induces vanadium reduction, which is reflected in the appearance of new states at the bottom of the conduction band edge and filled V 3d-O 2p states at the top of the valence band.

### DETAILED DISCLOSURE OF THE INVENTION

As used herein, the singular forms “a”, “an” and “the” are intended to include the plural forms as well, unless the context clearly indicates otherwise. Further, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, “comprise”, include the phrases “consisting essentially of”, “consists essentially of”, “consisting”, and “consists”. Such terms can be used interchangeably.

The phrases “consisting essentially of” or “consists essentially of” indicate that the claim encompasses embodiments containing the specified materials or steps and those that do not materially affect the basic and novel characteristic(s) of the claim.

The term “about” or “approximately” means within an acceptable error range for the particular value as determined by one of ordinary skill in the art, which will depend in part on how the value is measured or determined, i.e., the limitations of the measurement system. The term “about” can mean a range of up to 0-20%, 0 to 10%, 0 to 5%, or up to 1% of a given value. Where particular values are described in the application and claims, unless otherwise stated the term “about” meaning within an acceptable error range for the particular value should be assumed. When used in the context of amounts, times and/or temperatures within this application, the terms “about” or “approximately” represent a variation (error range) of 0-10% around the value (X±10%).

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc.

As used within the context of this application, the term “material of the invention” is intended to refer to the materials formed by the method disclosed herein, namely preintercalated β-NaₓV₂O₅ and/or β-K_{y}V₂O₅, where x is about 0.20 to about 0.34 and y is about 0.20 to about 0.33 (e.g., where x is about 0.20, 0.21, 0.22, 0.23, 0.24, 0.25, 0.26, 0.27, 0.28, 0.29, 0.30, 0.31, 0.33, and/or 0.34 or any combination of these value for “x”, y is about 0.20, 0.21, 0.22, 0.23, 0.24, 0.25, 0.26, 0.27, 0.28, 0.29, 0.30, 0.31, 0.32, and/or 0.33 or any combination of these “y” values, and any one of these “x” and “y” values can be included or excluded from the preintercalated material disclosed herein). The materials of the invention can then be intercalated with one or more ions selected from the group consisting of Li⁺ ions, Na⁺ ions, Al³⁺ ions, Y³⁺ ions, Ca²⁺ ions, Mg²⁺ ions, and Zn²⁺ ions, and combinations thereof. Na- and K-ion intercalation of the preintercalated β-NaₓV₂O₅ and/or β-K_{y}V₂O₅, where x is about 0.20 to about 0.34 and y is about 0.20 to about 0.33 “props” open the 1D tunnel, reduces electrostatic repulsions between inserted Li-ions, and entirely modifies diffusion pathways, enabling orders of magnitude higher Li-ion diffusivities and accessing higher capacities within cathodes comprising these materials. In one embodiment of the disclosed invention, the preintercalated β-NaₓV₂O₅ material has lattice constants comprising: comprising: a=15.3629 (7) Å, b=3.6109 (2) Å, and c=10.0502 (5) Å and wherein x=0.32. In another embodiment, preintercalated β-K_{y}V₂O₅ material has lattice constants comprising: comprising: a=15.4753 (10) Å, b=3.6123 (2) Å, and c=10.0693 (6) Å and wherein y=0.22. In various embodiments, batteries comprising a cathode comprising β-K_{0.22} V₂O₅ are capable of retaining their most of discharge capacity over at least several cycles (e.g., for at least three cycles). In some embodiments a material comprising preintercalated β-NaₓV₂O₅, where x is 0.33 can be excluded from the scope of the disclosed material. In other embodiments, the material comprises a mixture of forms of intercalated β-NaₓV₂O₅ and/or β-K_{y}V₂O₅, where x is about 0.20 to about 0.34 and y is about 0.20 to about 0.33. Thus, the material contains intercalated β-NaₓV₂O₅, where x is about 0.20, 0.21, 0.22, 0.23, 0.24, 0.25, 0.26, 0.27, 0.28, 0.29, 0.30, 0.31, 0.33, and/or 0.34 or any combination of these value for “x”. Similarly, the material can comprise different forms of preintercalated β-K_{y}V₂O₅, where y is about 0.20 to about 0.33 or where y is about 0.20, 0.21, 0.22, 0.23, 0.24, 0.25, 0.26, 0.27, 0.28, 0.29, 0.30, 0.31, 0.32, and/or 0.33 or any combination of these “y” values. Any one of these “x” and “y” values can be included or excluded from the preintercalated material disclosed herein.

In another aspect, the present disclosure provides a battery comprising a cathode comprising preintercalated β-NaₓV₂O₅ and β-K_{y}V₂O₅, where x is about 0.20 to about 0.34 and y is about 0.20 to about 0.33 disclosed herein. In some embodiments, a battery comprising preintercalated β-NaₓV₂O₅ where x is 0.33 can be excluded from the scope of the invention. In other embodiments, the battery comprises a mixture of forms of preintercalated β-NaₓV₂O₅, where x is about 0.20 to about 0.34 and/or β-K_{y}V₂O₅, where y is about 0.20 to about 0.33. Thus, the material contains preintercalated β-NaₓV₂O₅, where x is about 0.20, 0.21, 0.22, 0.23, 0.30, 0.25, 0.26, 0.27, 0.28, 0.29, 0.30, 0.31, 0.33, and/or 0.34 or any combination of these value for “x”. Similarly, the material can comprise different forms of preintercalated β-K_{y}V₂O₅, where y is about 0.20 to about 0.33 or where y is about 0.20, 0.21, 0.22, 0.23, 0.24, 0.25, 0.26, 0.27, 0.28, 0.29, 0.30, 0.31, 0.32, and/or 0.33 or any combination of these “y” values. Any one of these “x” and “y” values can be included or excluded from the preintercalated material disclosed herein. The cathode material can also comprise a combination of preintercalated β-NaₓV₂O₅ and β-K_{y}V₂O₅. In an embodiment, the cathode further comprises a conductive agent and a polymeric binder. The battery, in various embodiments, further comprises an electrolyte solution or suspension comprising a metal ion. Such an electrolyte solution or suspension is configured to contact the cathode and serve as a metal ion source for the cathode. In this regard, the battery is configured to reversibly cycle the insertion and extraction of metal ions to and from the cathode of the present disclosure. The metal ions that can be used to form the electrolyte solution or suspension are one or more ions selected from the group consisting of Li⁺ ions, Na⁺ ions, Al³⁺ ions, Y³⁺ ions, Ca²⁺ ions, Mg²⁺ ions, and Zn²⁺ ions, and combinations thereof. In various embodiments, the battery further comprises an anode selected from the group consisting of activated carbon cloth, Li metal, a Li alloy, an intermetallic compound containing Li, Mg metal, a Mg alloy containing Mg, and an intermetallic compound containing Mg (e.g., Mg—Bi, Mg—Sn, Mg—Sb). In an embodiment, the anode can comprise an activated carbon cloth.

The present disclosure also provides a method of making preintercalated β-NaₓV₂O₅ and β-K_{y} V₂O₅, where x is about 0.20 to about 0.34 (x is about 0.20, 0.21, 0.22, 0.23, 0.30, 0.25, 0.26, 0.27, 0.28, 0.29, 0.30, 0.31, 0.33, and/or 0.34 or any combination of these value for “x” and any of which can be included or excluded) and y is about 0.20 to about 0.33 (y is about 0.20, 0.21, 0.22, 0.23, 0.24, 0.25, 0.26, 0.27, 0.28, 0.29, 0.30, 0.31, 0.32, and/or 0.33 or any combination of these values for “y” and any of which can be included or excluded) comprising: reacting V₂O₅ and oxalic acid in water and heating the mixture to a temperature of between about 60° C. and about 100° C., preferably between about 70° C. and about 90° C., or at a temperature of about 80° C. or at a temperature of 80° C. and adding sodium nitrate or potassium nitrate to the solution. The method further comprises stirring the mixture and, optionally, continued heating of the mixture until free water is evaporated and a powder is obtained. The method can further comprise the grinding of the powder and annealing of the powder under ambient conditions in a furnace (for example in a muffle furnace at a temperature of about 450° C.) for a period of about 6 hours or a period of about 3 to about 9 hours (e.g., a period of about 3, 4, 5, 6, 7, 8, or 9 hours). Materials formed by this process can then be formed into components of a battery (i.e., a cathode). The subject disclosure also provides for materials produced by the disclosed process.

### Materials and Methods

Growth of Single Crystals of β-NaₓV₂O₅ and β-KₓV₂O₅: As reported previously,⁵⁹ powders of the intercalated β-MₓV₂O₅ species were synthesized from stoichiometric amounts of Na₂C₂O₄ (≥99.5%, Sigma Aldrich) or K₂C₂O₄ (≥99.5%, Sigma Aldrich) and α-V₂O₅ powder (≥99.6%, Alfa Aesar) that were ball-milled (Spex mill, acrylic beads) for 2 h and then annealed in alumina boats under argon atmosphere at 550° C. for 24 h. Single-crystals were obtained by ball-milling these powders a second time, and then sealing the powders in evacuated quartz ampoules, melting at 800° C., and then slow-cooling through the melting point at a rate of 2°/h. This method yielded large, lustrous black crystals with a plate-like habit.

Topochemical Lithiation of β-Na_{0.32} V₂O₅ and β-K_{0.22} V₂O₅ Single Crystals: After high-quality crystals in the desired stoichiometric range had been identified, ca. 5 mg of pristine β-Na_{0.32} V₂O₅ crystals were topochemically lithiated with retention of the original crystal lattice by immersion in 10 mL of n-butyllithium solution (Sigma Aldrich, 2.5M in hexanes) diluted to 0.02M with heptanes for 24 h (Table 14), to concentrations of 0.02M and 0.033M for β-Na_{0.32} V₂O₅ and β-K_{0.22} V₂O₅, respectively. The potential of n-BuLi is estimated to be ca. 1.0 V vs. Li⁺/Li.⁶⁰ After topochemical treatment at this concentration, crystals retained their black, plate-like habit with minimal damage and cracking, likely due to pre-intercalated cations acting as a structural buttress for the tunnel.

Synthesis of 2-V₂O₅ Powder: As reported previously,³⁰ V₂O₅ (≥98%, Sigma Aldrich) and silver acetate were dispersed in deionized water (ρ=18.2 MΩ/cm) and then reacted hydrothermally at 210° C. for 5 days. After washed with a large amount of water and isopropanol, the obtained β-Ag_{0.33} V₂O₅ powder was reacted with hydrochloric acid solution to leach Ag⁺. ζ-V₂O₅ was obtained after washing with sodium thiosulfate solution (10 wt. %) and deionized water.

Synthesis of β-Na_{0.25}V₂O₅ and β-K_{0.27}V₂O₅ Powders: In a typical synthesis, 1.82 g orthorhombic V₂O₅ (≥98%, Sigma Aldrich) and 2.7 g oxalic acid (≥98%, Sigma-Aldrich) were dispersed in 100 mL deionized water (ρ=18.2 MΩ/cm) within a beaker, which was placed on a heating plate held at 80° C. The dispersion was vigorously stirred using a magnetic stirrer. After the solution turned deep-blue in color, the alkali metal nitrate salt (0.2125 g NaNO₃ or 0.2730 g KNO₃) was added to the blue solution and vigorously stirred under open air until free water was evaporated and sponge-textured dark-brown powder was obtained. The recovered solid was then ground using mortar and pestle and annealed under ambient condition in a muffle furnace at 450° C. for 6 h.

Single Crystal Diffraction: Single-crystal diffraction data was collected on a BRUKER Quest X-ray diffractometer utilizing the APEX3 software suite, with X-Ray radiation generated from a Mo-Iμs X-ray tube (Kₐ=0.71073 Å). All crystals were placed in a cold N₂ stream maintained at 110 K. Four different single crystals of β-Na_{0.32} V₂O₅ were solved and do not show any evidence of segregation/supercell ordering prior to Li-ion insertion. A second, separately-lithiated β-NaₓV₂O₅ crystal exhibited the same Li- and Na-ion ordering pattern upon structure solution and refinement.

Following unit cell determination, extended data collection was performed using omega and phi scans. Data reduction, integration of frames, merging, and scaling were performed with the program APEX3, and absorption correction was performed utilizing the program SADABS. Structures were solved using intrinsic phasing, and least-squares refinement for all structures was carried out on F². Structural refinement and the calculation of derived results were performed using the SHELXTL package of computer programs and ShelXle.^{61,62} Detailed refinement and crystal information is contained in the Tables 2-7, 11-13, and 15-17. Crystallographic Information Files (CIFs) of our new refinements of β-Na_{0.32}V₂O₅ and β-K_{0.22} V₂O₅ used in this study, as well as of the new structures β-Na_{0.32}/β′-Li_{0.33} V₂O₅ and β′-Li_{0.23}/β-K_{0.22} V₂O₅, have been deposited in the Cambridge Structural Database and are available for access with deposition numbers 2150932, 2150933, 2150934, and 2203830, respectively.

Morphological Characterization: Scanning electron microscopy (SEM) was conducted on a JOEL JSM-7500F FE-SEM operated at an accelerating voltage of 5 kV.

Electrochemical Characterization: CR2032 coin cells were prepared in a glovebox filled with Ar. The working electrode was prepared by casting the mixture of the active material (ζ-V₂O₅, β-Na_{0.25} V₂O₅ or β-K_{0.27}V₂O₅, 70 wt. %), conductive carbon (Super C45, 20 wt. %), and binder [poly(vinylidene fluoride), 10 wt. %] dispersed in N-methyl-2-pyrrolidone onto an Al foil substrate, following by drying at 70° C. in a forced air oven. The counter electrode and separator were lithium metal and Celgard 2500, respectively. The electrolyte was 1M LiPF₆ in a solvent mixture of ethylene carbonate and diethyl carbonate with a volume ratio of 1:1. The cells were galvanostatically discharged and charged in a voltage range of 2-4 V using a LANHE (CT2001A) battery testing system. Cyclic voltammetry (CV) measurements were performed using a Bio-Logic electrochemical potentiostat in the voltage range of 2-4 V. In order to determine Li-ion diffusivities, cyclic voltammetry was performed at different scan rates.

Li-ion diffusivities can be extrapolated by using Randles-Sevcik equation:^{63,64}

$${i}_{p} = ( 2.69 \times {10}^{5} ) {n}^{3 / 2} {SD}_{{Li}^{+}}^{1 / 2} {C}_{Li}^{*} {v}^{1 / 2} \qquad ( Eq . 1 )$$

where iₚ represents the peak current at reduction/oxidation states; n is the number of electrons transferred in the redox reaction; S refers as the area of electrode (cm²);

$${C}_{Li}^{*}$$

is the concentration of Li-ions (mol/cm³), and ν is the scan rate used in the experiment.

For long-term cycling measurements, the electrodes were prepared by mixing the active material (ζ-V₂O₅, β-Na_{0.25}V₂O₅, or β-K_{0.27}V₂O₅, 80 wt. %) with conductive carbon (Super P C-45, MSE Supplies, 10 wt. %) and binder [poly(vinylidene fluoride), 10 wt. %]. The composite was added to N-methyl-2-pyrrilodone (NMP) solvent and mixed with a high shear mixer to create a homogenous slurry. Subsequently, the slurry mixture was laminated onto a carbon-coated aluminum foil current collector (MTI Corporation) and dried to remove NMP solvent. Dried electrodes with an area of 1.32 cm² contained 9-15 mg of active material and were assembled in CR2032 coin cells in an Argon-filled glovebox. Lithium metal chips were used as the counter electrode and Celgard 2320 were used as separators. The electrolyte was a solution of 1 M LiPF₆ in a 1:1 (v/v) solvent mixture of ethylene carbonate and ethyl methyl carbonate. The cells were charged under constant current constant voltage (CCCV) and discharged under constant current (CC). All coin cells were cycled at a C-rate of C/20 between 2.2-3.7 V for first three cycles for electrode-electrolyte interface stabilization, followed by cycling at C-rate of C/5 for 100 cycles.

Operando Synchrotron X-ray Diffraction: Electrodes for operando X-ray diffraction studies were constructed by mixing carbon black (Vulcan XC-72, Cabot Corporation), graphite (300 mesh, 99%, Alfa Aesar), PTFE binder (Sigma-Aldrich), and as-prepared β-Na_{0.25} V₂O₅ or β-K_{0.27}V₂O₅ in a ratio of 7.5:7.5:15:70 (w/w/w/w) using a mortar and pestle. The mixture was pressed into a 10 mm diameter pellet as the working electrode. Lithium metal (Sigma-Aldrich) and glass fiber were used as the reference electrode and separator, respectively. The electrolyte was 1M LiPF₆ in a solvent mixture of ethylene carbonate and diethyl carbonate with a volume ratio of 1:1. The AMPIX cell, which replicates a coin cell configuration but is equipped with Kapton tape protected the glassy carbon X-ray transmissive windows, was assembled in a glove box at argon atmosphere to enable operando studies.⁶⁵ Operando synchrotron XRD was performed at beamline 17-BM-B at the Advanced Photon Source (APS) using a wavelength of 0.24117 Å with an amorphous silicon flat panel detector.

Synchrotron X-ray datasets were analyzed using GSAS II, an open-source crystallography package.⁶⁶ 2D images were masked and integrated using a LaB₆ standard for calibration. Background scans were performed on cells with the anode, electrolyte, and separator but without a cathode. Rietveld refinements and Pawley refinements were performed on select diffraction data to evaluate the lattice parameters based on structural models derived from the Inorganic Crystal Structural Database as well as single-crystal structure solutions.

Computational Methodology: Transition pathway predictions were performed based on the Climbing Image Nudged Elastic Band (CI-NEB) method,⁶⁷ within the framework of the DFT formalism,^{68,69} as implemented in the Vienna ab-initio simulation package.⁷⁰ The projected-augmented-wave (PAW)⁷¹ formalism has been used for electronic structure calculations; the generalized gradient approximation (GGA)⁷² along with a Hubbard U parameter has been used to treat delocalization of 3d electrons of vanadium. A converged plane wave basis set with a 500 eV kinetic energy cut-off with 3×3×3 and 5×5×5 Monkhorst Pack K-points have been used for geometry optimization and density of states calculations, respectively⁷³. After obtaining fully relaxed structures, the ion-migration mechanism has been examined by the CI-NEB methods along a sequence of 7 images. All the structures are completely relaxed with the minimum-energy criteria until the Hellman-Feynman force decreases below 0.01 eV/Å.

All patents, patent applications, provisional applications, and publications referred to or cited herein are incorporated by reference in their entirety, including all figures and tables, to the extent they are not inconsistent with the explicit teachings of this specification.

Following are examples which illustrate procedures for practicing the invention. These examples should not be construed as limiting. All percentages are by weight and all solvent mixture proportions are by volume unless otherwise noted.

### EXAMPLE 1

### Results and Discussion

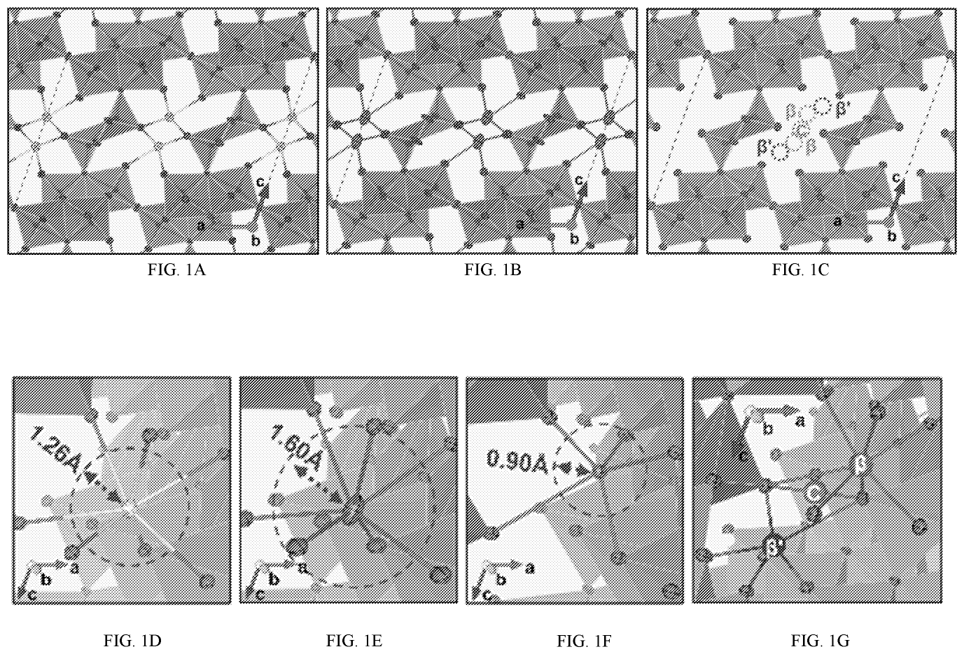

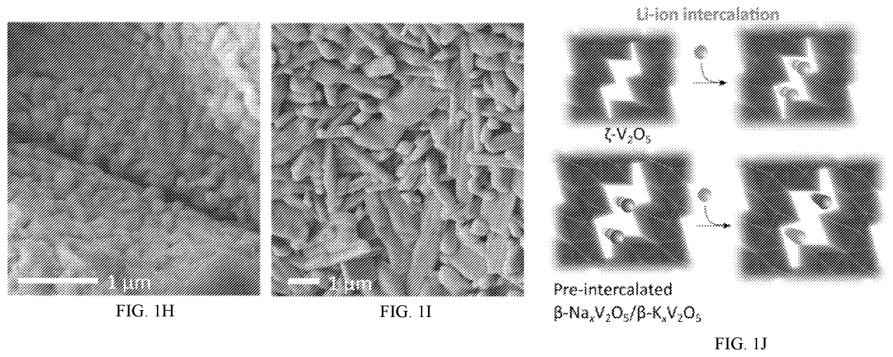

Single crystals of β-Na_{0.32} V₂O₅ and β-K_{0.22}V₂O₅ have been obtained from melt growth of powders synthesized from Na₂C₂O₄/K₂C₂O₄ and α-V₂O₅ as described in the Methods section.^{32,36,38,39} Single-crystal structure solutions were obtained at 110K and are shown in FIGS. 1A and 1B for β-Na_{0.32} V₂O₅ and β-K_{0.22} V₂O₅, respectively, and are contrasted to the empty metastable 1D polymorph ζ-V₂O₅ (FIG. 1C).²⁹ Crystallographic refinement information for β-Na_{0.32}V₂O₅ and β-K_{0.22} V₂O₅ structures are listed in Tables 2-7; CIF files have been deposited in the Cambridge Structural Database with deposition numbers 2150932-2150933. These compounds crystallize in monoclinic unit cells with space group C2/m with three crystallographically inequivalent vanadium atoms. The structure is characterized most prominently by a 1D tunnel arrayed along the crystallographic b axis, which is surrounded by zigzag chains of edge-sharing [VO₆] and corner-sharing [VO₆] distorted octahedra stitched together with [VO₅] square pyramids.^{32,40,41} FIGS. 1C and 1F illustrates β, β′ and C interstitial sites available in the tunnels of ζ-V₂O₅, which enable accommodation of up to 2 monovalent ions per formula unit when completely filled.^{38,41} The pre-intercalated Na- and K-ions occupy a fraction of interstitial β sites along the tunnels with ca. 50% occupancy evenly distributed across the β sites, and with some evidence for ordering across alternating tunnels.^{35,36,40} FIGS. 1D and 1E illustrate the 7-fold distorted pentagonal-bipyramidal local coordination environments of the pre-intercalated alkali metal ions residing in the β-site within the V₂O₅ tunnel, compared with the 5-fold distorted trigonal-bipyramidal coordination environment of Li in the β′-site (FIG. 1F). The other interstitial sites along the tunnel, shown in context in FIGS. 1C and 1G, remain available and accessible for Li-ion insertion as will be examined by operando synchrotron X-ray diffraction. While pre-intercalation does not alter the C2/m space group, in comparison to (ζ-V₂O₅, the a unit cell parameter is expanded and the β angle is compressed resulting in an overall volume expansion of 0.76% and 2.5% 43 for Na- and K-ion pre-intercalation, respectively.³⁰ The observed larger volume expansion for the latter is readily rationalized based on the larger crystal radius (1.60 Å) for 7-coordinate K⁺ as compared to 7-coordinate Na⁺ (1.26 Å), which are indicated by dashed lines in FIGS. 1D and 1E.⁴⁴

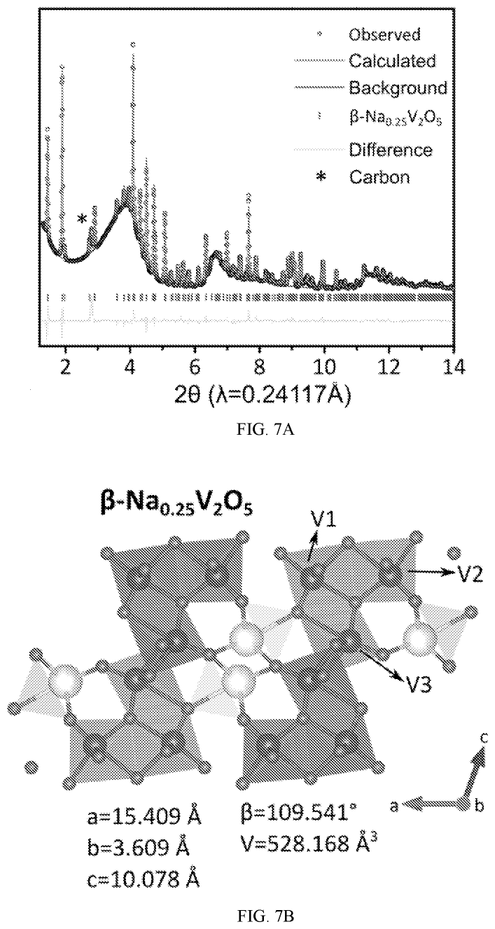

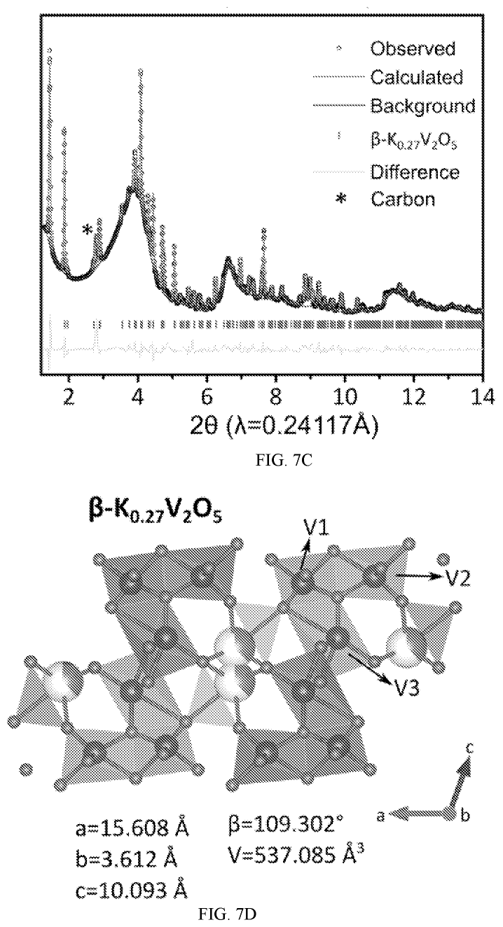

In order to construct porous intercalation cathodes for operando studies and evaluation of electrochemical performance, powders of β-NaₓV₂O₅ and β-KₓV₂O₅ have been prepared by the reaction of V₂O₅ with nitrate salts as described in the Methods section. FIGS. 7A-7D show Rietveld refinements to the XRD patterns and the refined structures, which are consistent with the single-crystal structure solutions and correspond to nominal stoichiometries of β-Na_{0.25}V₂O₅ and β-K_{0.27}V₂O₅. Refinement statistics are tabulated in Tables 8 and 9. Scanning electron microscopy (SEM) images of β-Na_{0.25}V₂O₅ and β-K_{0.27}V₂O₅ particles in FIGS. 1H and 1I reveal microbeam morphologies with lateral dimensions of 140±18 nm 218±41 nm, respectively. The rods have lengths of 400±10 nm and 1.4±0.2 μm for β-Na_{0.25}V₂O₅ and β-K_{0.27}V₂O₅, respectively.

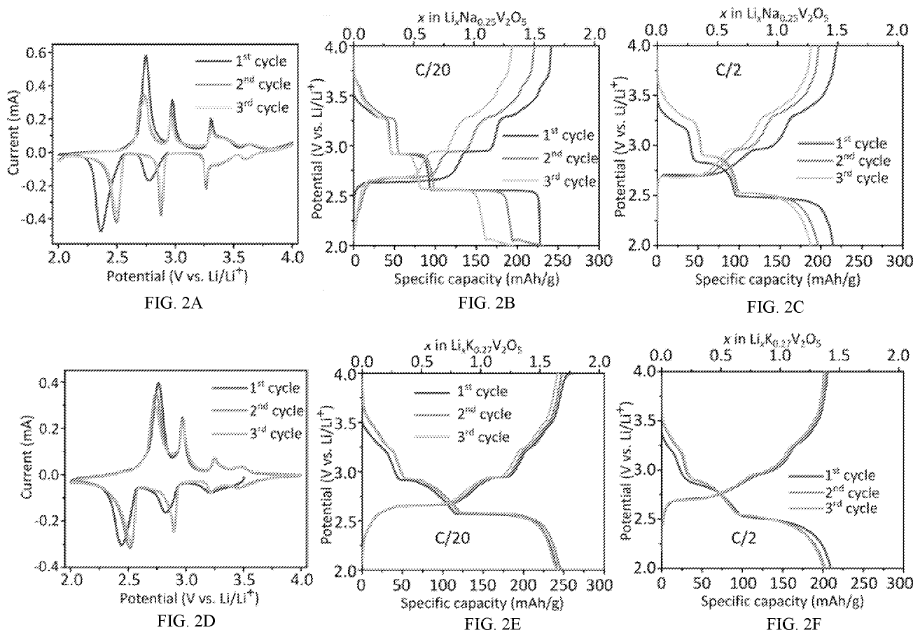

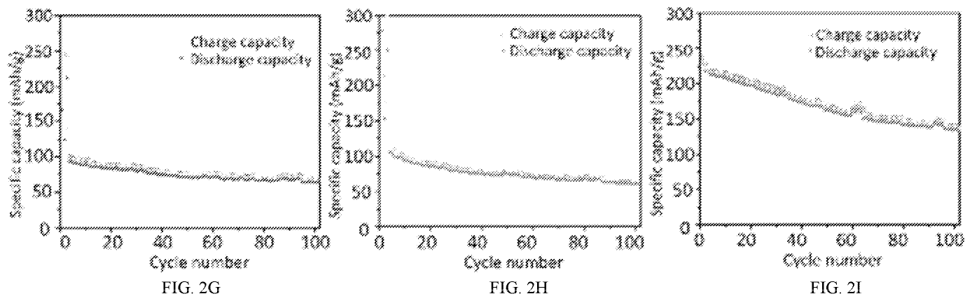

The electrochemical performance of β-Na_{0.25}V₂O₅ and β-K_{0.27}V₂O₅ have been contrasted by means of cyclic voltammetry and galvanostatic discharge/charge measurements, as shown in FIGS. 2A-21 and FIGS. 8A-8F. Detailed electrochemical characterization of ζ-V₂O₅ has been reported in previous work.³¹ For both β-Na_{0.25}V₂O₅ and β-K_{0.27}V₂O₅, reduction peaks at 2.78 and 2.37 V in FIG. 2A, and 2.82 and 2.44 V in FIG. 2D, are shifted to slightly higher potentials from the first to the second cycle, as a result of surface changes accompanying the formation of a cathode electrolyte interface film.⁴⁵⁻⁴⁷ In FIG. 2A, reduction peaks located at 3.27, 2.88, and 2.50 V in the second cycle for β-Na_{0.25}V₂O₅ are consistent with potential slopes/plateaus in the discharge curves in FIG. 2B. Similarly, the reduction peaks at 3.21, 2.90, and 2.51 V for β-K_{0.27}V₂O₅ are concordant with potential slopes/plateaus measured in the discharge curves in FIG. 2E. In analogy with lithiation of ζ-V₂O₅, the potential slopes/plateaus are ascribed to Li-ion reordering along the tunnels at different occupancies, as will be evidenced using operando XRD measurements (vide infra). 38

The current values measured in cyclic voltammograms are preserved to a greater extent for β-K_{0.27}V₂O₅ as compared to β-Na_{0.25}V₂O₅, which suggests a relatively greater reversibility of electrochemical lithiation. FIG. 2B shows that the initial charge capacity of β-Na_{0.25} V₂O₅ is 241.5 mAh/g but is decreased to 194 mAh/g after three cycles at a C-rate of C/20. In contrast, the initial charge capacity of β-K_{0.27}V₂O₅ is 242 mAh/g and is essentially retained after three cycles (FIG. 2E). For comparison, the charge capacity of ζ-V₂O₅ is 228.7 mAh/g after 3 cycles which is decreased from 250.9 mAh/g in the first cycle at the C-rate of C/20, as reported in previous work.³⁰

Upon cycling at a higher C-rate of C/2, β-Na_{0.25}V₂O₅ presents an initial discharge capacity of 214.7 mAh/g, which is decreased to 196.7 mAh/g in the second cycle, and then to 187.5 mAh/g in the third cycle (FIG. 2C). In contrast, β-K_{0.27}V₂O₅ exhibits an initial discharge capacity of 209.7 mAh/g at a C-rate of C/2; a capacity of 200.2 mAh/g is observed to be retained after 3 cycles.

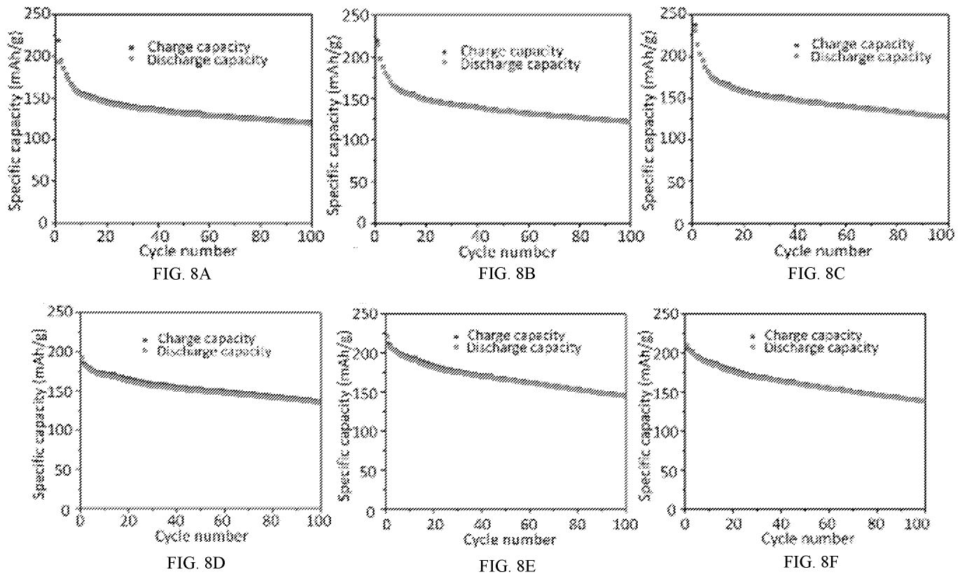

Greater capacity fading at higher C-rates is attributable to limitations in solid-state Li-ion diffusivity, which presents a kinetic impediment to realizing the accessible insertion capacity, and further points to the need to optimize crystallite geometry, reduce particle agglomeration, and identify compatible electrolytes for the different compounds considered here.⁴⁸⁻⁵⁰ At a C-rate of C/2, extended cycling has been performed in the window 2-4 V. Porous electrodes constructed from β-Na_{0.25}V₂O₅ and β-K_{0.27}V₂O₅ both show a Columbic efficiency of nearly 100%. Based on measurements of three separate cells (FIGS. 8A-8F), β-Na_{0.25}V₂O₅ exhibits an initial capacity of 212.9±18.9 mAh/g, which is decreased to 136.3±6.9 mAh/g after 50 cycles and substantially diminished to 122.5±3.8 mAh/g after 100 cycles, an overall decrease of ca. 58%. In contrast, β-K_{0.27}V₂O₅ has a capacity of 202.7±14.4 mAh/g in the first cycle, is decreased to 158.3±7.4 mAh/g after 50 cycles and subsequently decreased to 139.4±5.0 mAh/g after 100 cycles, a more modest decrease in capacity of ca. 30%. As such, β-K_{0.27}V₂O₅ exhibit better capacity retention than β-Na_{0.25}V₂O₅ at a higher C-rate.

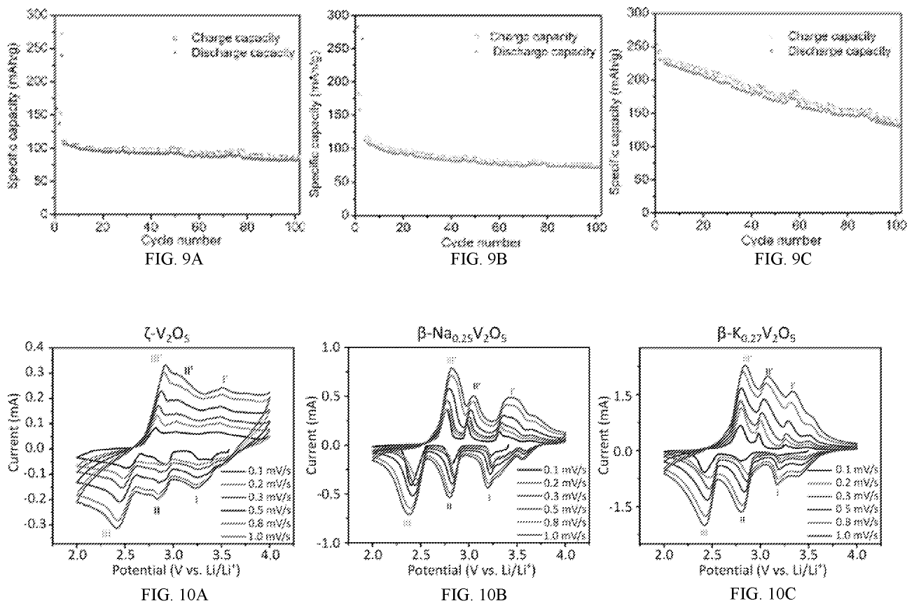

Also, to better compare long-term cycling performance of β-Na_{0.25}V₂O₅ and β-K_{0.27}V₂O₅ with that of ζ-V₂O₅, an alternative set of cycling conditions have been examined. Coin cells are cycled between 2.2 to 3.7 V at a C-rate of C/20 in the first three cycles to stabilize the electrode/electrolyte interface, and thereafter at C/5 for 100 cycles, as shown in FIGS. 2G-2I (FIGS. 9A-9C shows additional datasets). Under these conditions, ζ-V₂O₅ shows a capacity of 105 mAh/g after 3 cycles and 78 mAh/g after 100 cycles. β-Na_{0.25}V₂O₅ shows 115 mAh/g after 3 cycles and 69 mAh/g after 100 cycles. β-K_{0.27}V₂O₅ exhibits 220 mAh/g after 3 cycles and 137 mAh/g after 100 cycles, which is higher than that of ζ-V₂O₅. The pre-intercalated Na-ions and K-ions effectively enlarge the tunnel spacing, leading to larger initial capacity. However, β-Na_{0.25}V₂O₅ shows lower capacity than ζ-V₂O₅ after 100 cycles, which is ascribed to the re-ordering of Na-ions, which resulting in only one side of the tunnel being accessible (vide infra) and to greater diffusivity of Na-ions, which show a greater proclivity for deinsertion. In contrast, larger K-ions significantly expand the tunnel spacing, have much larger migration barriers that holds the pillaring in place, thereby substantially boosting capacity. The greater capacity loss upon initial cycling at C/20 is explicable considering that stoichiometric gradients are most pronounced upon deep discharge, which engenders greater structural distortions, opportunities for de-insertion of pillaring ions, and eventual capacity loss. In contrast, for the same potential window, the greater overpotential at a higher C rate restricts the extent of lithiation and magnitude of structural distortions. Consistent with this explanation, an additional voltage plateau at 2.05 V observed after the first cycle (discharged from 4.0 to 2.0 V) in FIG. 2B attests to greater structural distortion at the lower rate. This additional structural change is directly correlated with accelerated capacity fading. At a C-rate of C/2, the voltage plateau at 2.05 V is not observed.

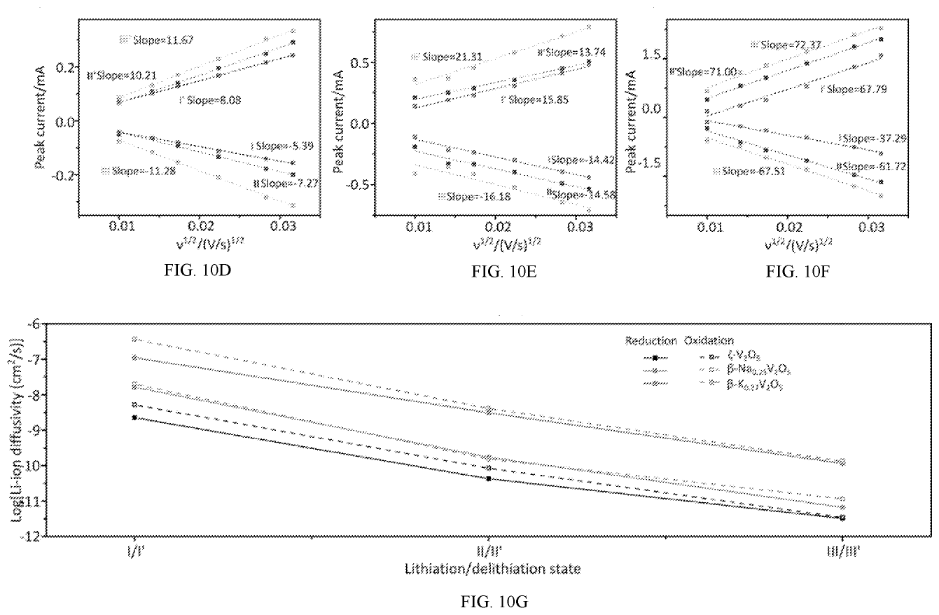

In order to investigate rate capacity and the kinetics of Li-ion insertion in the pre-intercalated compounds, scan-rate-dependent cyclic voltammetry has been used to infer Li-ion diffusivities in the pre-intercalated compounds at different stages of lithiation/delithiation (FIGS. 10A-10G and Table 10). With increasing concentration of Li-ions in the tunnels, Li-ion diffusivities are gradually decreased as progressively less energetically favored sites are occupied with increasing repulsion between Li-ions.^{36,38} A primary caveat is that while the particle loadings and geometries have been kept consistent to the extent possible and the systems here do not undergo first-order intercalation-induced phase transitions, [31] the active surface area of composite electrodes can be difficult to estimate. The corresponding Li-ion diffusivity values for β-Na_{0.25}V₂O₅ across the intercalation regimes I-III (Table 10) reflect an over one order of magnitude enhancement as compared to ζ-V₂O₅. An additional order of magnitude enhancement of Li-ion diffusivity is observed in the expanded tunnels of β-K_{0.27}V₂O₅. The remarkable enhancement in diffusivity as a result of tunnel expansion through pre-intercalation is further examined using density function theory (DFT) simulations in subsequent sections.

To decipher the mechanistic basis for how pre-intercalation impacts electrochemical performance, we have first topochemically lithiated an entire single crystal of β-Na_{0.25}V₂O₅. In contrast to the much more limited resolving power of powder X-ray diffraction, single-crystal X-ray diffraction enables mapping of Li occupancies with sub-Ångstrom-level resolution—this has rarely been achieved in battery science given the difficulties in growing and topochemically lithiating singe crystals of insertion hosts with preservation of macroscopic single crystalline domains. As compared to direct preparation of lithiated compounds wherein Li-ions are ensconced in thermodynamically favored sites, topochemical intercalation of single crystals captures electron density maps derived from Li-ions traversing across the crystal lattice, and thereby allows for tracing of diffusion pathways and identification of site preferences.^{29,51,52} Furthermore, we have used operando synchrotron XRD to map the dynamical evolution of structure during lithiation/delithiation. In combination, the two methods provide a comprehensive picture of topochemical lithiation in these materials across length scales: single-crystal diffraction affords an atomistic view of site occupancy and diffusion within individual domains; whereas operando powder diffraction maps out bulk transformation under operational conditions using structure solutions available from single-crystal diffraction as useful benchmarks.

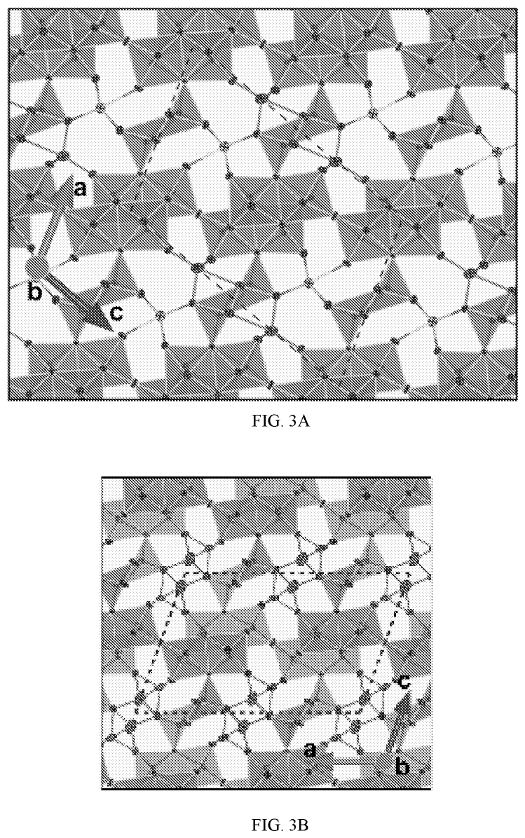

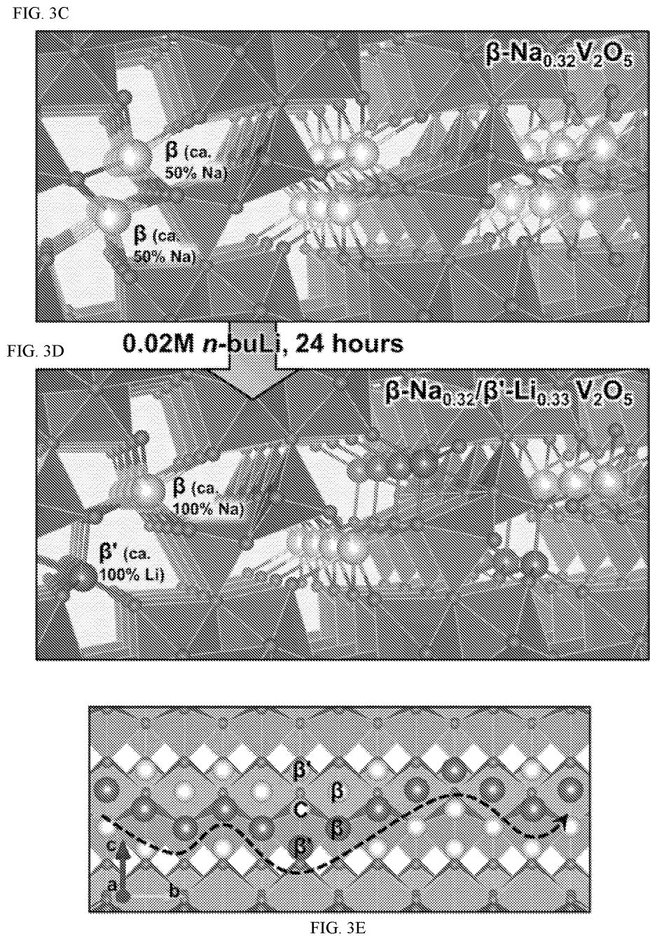

FIG. 3A shows the extended structure of topochemically lithiated β′-Li_{0.33}β-Na_{0.32} V₂O₅ prepared by single-crystal-to-single-crystal transformation of pristine β-Na_{0.32}V₂O₅ crystals and refined from high-resolution single-crystal X-ray diffraction data as described in the methods section (least-squares residual R1=4.7%). Crystallographic refinement information for β′-Li_{0.33}β-Na_{0.32} V₂O₅ structure are listed in Tables 11-13, and CIF file of this structure has been deposited in the Cambridge Structural Database and are available to access with deposition numbers 2150934. The refined cation stoichiometries for this crystal agree well with ICP-MS analysis, which indicate an average of 0.36 Li and 0.25 Na per V₂O₅ (Table 14). Upon chemical lithiation, a pronounced ordering of the Na-ions is discerned along every 7-coordinated β-site on one side of the tunnel, whereas Li-ions segregate to every 5-coordinated β′-site on the opposite side of the tunnel. This lopsided filling pattern, which alternates in adjacent tunnels, has the effect of creating a screw axis in the structure and changing the space group from C2/m to P21/m. It should also be noted that the centering of the screw axis also changes the setting of the unit cell relative to the pristine β-Na_{0.32}V₂O₅ structure, and consequently the unit cell orientation, while retaining the monoclinic lattice parameters of the pristine structure, is rotated (indicated by dashed boundaries in FIG. 3A, compared to the retained C2/m symmetry of the lithiated β-K_{0.22} V₂O₅ structure in FIG. 8B). The introduction of a screw axis arising from cation rearrangement represents a previously-unobserved form of ordering in tunnel-type MₓV₂O₅ bronzes.^{53,54} These compounds have been seen to exhibit supercells at low temperature arising from a zig-zag filling of β sites,^{53,54} but not straight chains of β- and β′-sites as reported here.). FIGS. 3B and 3C show a perspective view of the tunnels in the structure in both the pristine β-Na_{0.32}V₂O₅ crystal (FIG. 3B), where Na ions are randomly distributed with ca. 50% occupancy across all available β-sites; and in a crystal of the same sample that has been lithiated with 0.02M n-butyllithium in heptanes overnight (FIG. 3C), where the insertion of lithium has forced a rearrangement of cations.

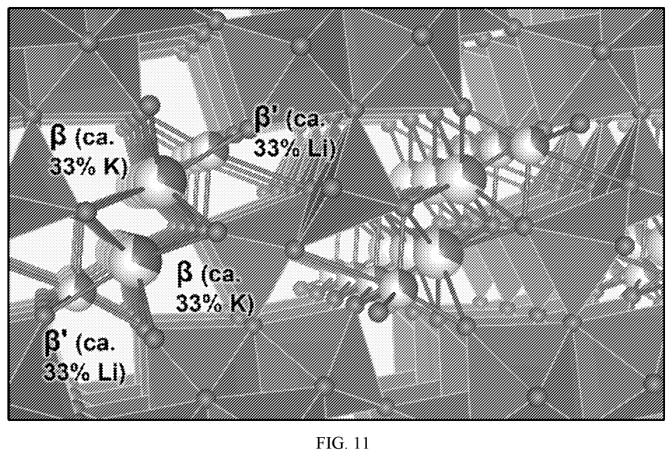

FIG. 3B shows a structure of β′-Li_{0.23}/β-K_{0.22} V₂O₅ that was accessed similarly by topochemical treatment of pristine β-K_{0.22}V₂O₅ crystals in an n-butyllithium solution as described in the Methods. A ca. 66% higher concentration of n-butyllithium was necessary (0.033 M, compared to 0.02M for β-Na_{0.32}V₂O₅) to lithiate β-K_{0.22} V₂O₅. In contrast to the distinctive cation ordering induced by Lit insertion in β-Na_{0.32}V₂O₅, the lithiated β′-Li_{0.23}/β-K_{0.22} V₂O₅ structure shows a random distribution of K and Li at the β- and β′-sites, respectively (shown in FIG. 11), albeit with high site selectivity for the two cations (K-ions in β-sites and Li-ions in β′ sites). The lithiated crystal preserves the C2/m symmetry of the parent phase in agreement with the powder X-ray diffraction data in Table 1. The difference in ordering behavior between Na- and K-ions on the introduction of Li-ions arises from the lower mobility of K⁺ and greater ionic repulsions, which prevents facile rearrangement of all ions on one side of the tunnel. The contrast between the two pre-intercalated ions highlights the potential for site-selective modification through pre-intercalation to redirect Li-ion diffusion pathways.

The view of the lithiated pre-intercalated tunnel in FIG. 3D, where Na-ions fill all β-sites on one side of the tunnel, and Li-ions fill all β′-sites on the opposite side, contrasts with the diffusion pathway inferred for ζ-V₂O₅ from single-crystal-to-single crystal transformations sketched in FIG. 3E.^{39,30} Whereas in empty ζ-V₂O₅, all sites are equally available to Li-ions and mirrored across the center of the tunnel, pre-intercalation with Na-ions bifurcates and limits Li-ion diffusion to one half of the tunnel. The atomic resolution single-crystal data thus demonstrates with remarkable clarity that pre-intercalation alters the diffusion pathways and sequence of sites accessed by Li-ions traversing across the lattice. Furthermore, the use of topochemical transformation on a large single-crystal of a pre-intercalated species highlights the potential versatility of this method, which has previously only been applied to crystals of “empty” polymorphs.^{29,51,52} We posit that topochemical crystal-to-crystal transformation therefore holds promise for generalizability to insertion hosts that 1) undergo distortion continuously without abrupt distortive transformations, 2) transform without substantial breaking of bonds or rearrangement of atoms in the host lattice, and 3) can be transformed slowly enough that local strain gradients do not cause mechanical degradation.

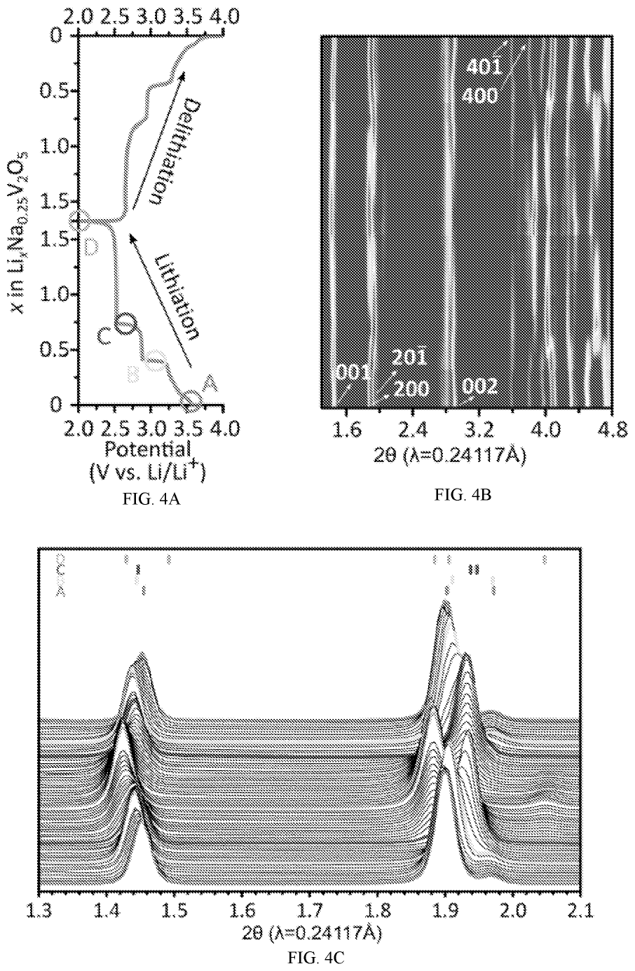

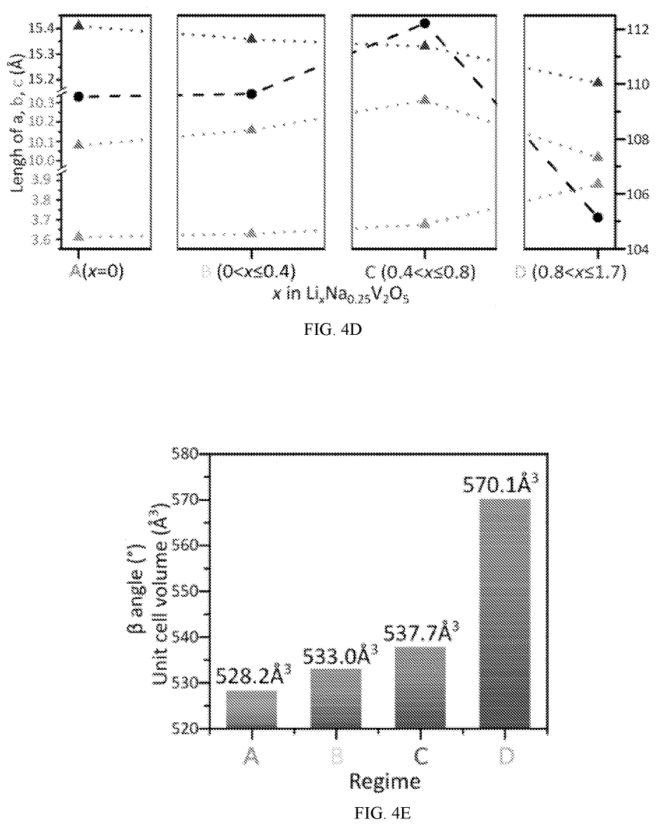

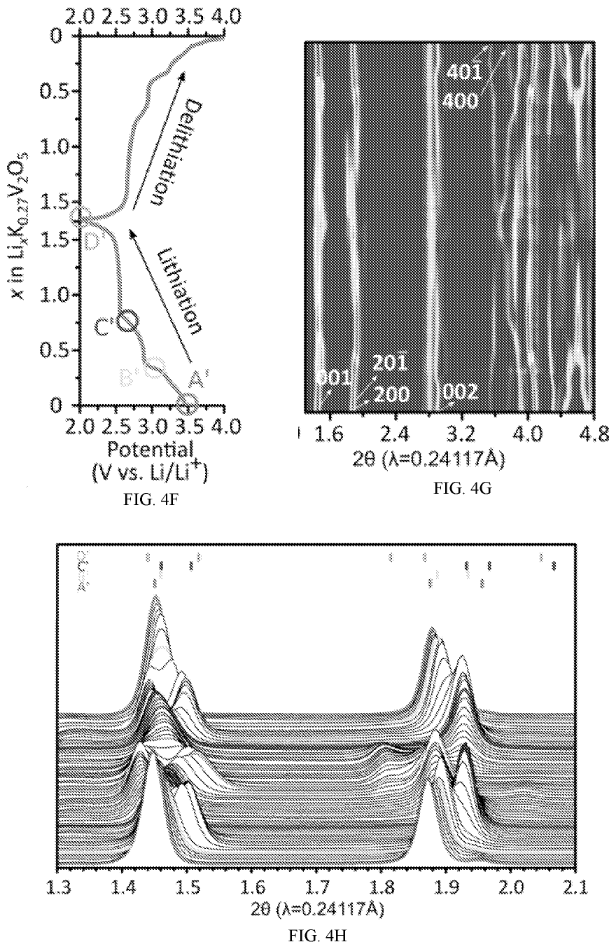

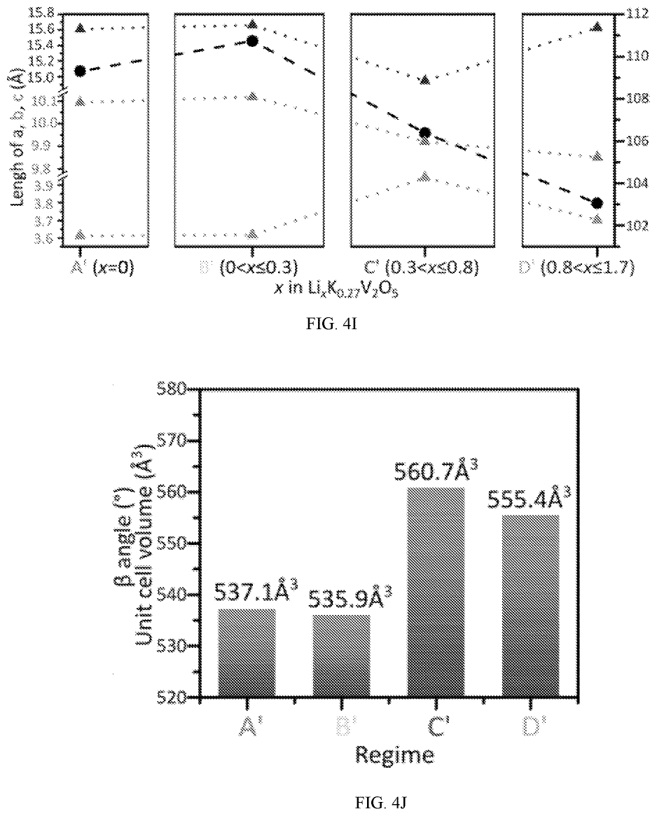

We next turn our attention to operando synchrotron X-ray diffraction studies, which have been performed for both pre-intercalated compounds using AMPIX cells as described in the Methods section. The discharge/charge profiles of β-Na_{0.25}V₂O₅ and β-K_{0.27}V₂O₅ in FIGS. 4A and 4F exhibit potential slopes/plateaus that are entirely consistent with those in FIGS. 2B and 2E, respectively. In addition, the corresponding contour plots in FIGS. 4B and 4G indicate that the lithiation/delithiation processes are entirely reversible for both β-Na_{0.25}V₂O₅ and β-K_{0.27} V₂O₅.

In order to comprehensively study the structural changes during lithiation/delithiation, Pawley refinement has been performed to obtain lattice parameters as the function of lithiated states, as shown in Table 1. FIGS. 4A-4J plot the change in lattice parameters, unit cell volume, and the monoclinic β angle as a function of lithiation delineating distinctive intercalation regimes. The local vanadium coordination (O—V—O bond angles and V—O bond lengths) in β-MₓV₂O₅ is remarkably stable with respect to changes in the identity and concentration of intercalated ions; the V₂O₅ host lattice can be considered to be constituted from rigid VOₓ polyhedra connected by flexible V—O—V joints. It is the flexibility of these bond angles that allows the unit cell to expand or contract while preserving overall V—O connectivity. The specific interstitial sites occupied by Li-ions within the tunnels of β-Na_{0.25}V₂O₅ and β-K_{0.27}V₂O₅ have been inferred from single-crystal X-ray diffraction studies of chemically prepared single crystals of β/β′-LiₓV₂O₅²⁹ (FIG. 1C) and lithiated β-Na_{0.25}V₂O₅/β-K_{0.22} V₂O₅ as shown in FIGS. 3A-3E and FIG. 11. As observed in the single-crystal structures, cation insertion and pre-intercalation have a marked impact on the symmetry of the structures, which adopt different space groups during continuous transformation that can be observed in the appearance/disappearance of new reflections in the PXRD patterns shown in FIGS. 4A-4J, as also listed in Table 1. However, these changes in symmetry result not from flexions around polyhedral lattices (such distortions indeed entirely preserve the lattice symmetry), but are entirely attributable to rearrangement of Li, Na, and K cations in the ζ-V₂O₅ tunnels. Indeed, this is observed directly in the single-crystal structures shown in FIGS. 4A-4J where the monoclinic host lattice is otherwise continuously distorted.

For β-Na_{0.25}V₂O₅, during the discharging process, initial Li-ion intercalation upon discharge to 3.06 V (0<x≤0.4, x in LiₓNa_{0.25}V₂O₅) slightly expands the tunnel structure to 532.956 Å³ with the same C2/m space group ascribed to Li-ions occupying β′ sites. Upon discharge to 2.53V (0.4<x≤0.8, x in LiₓNa_{0.25}V₂O₅), the symmetry of the structure is maintained but with expansion of the tunnel evidenced by an increase of the unit cell volume to 537.734 Å³ and increased distortion of the monoclinic β angle to 112.218°, which corresponds to a highly-lithiated ζ-V₂O₅ structure where β- and β′-sites are both occupied and C-sites begin filling.²⁹ Further lithiation to 2.0V (0.8<x≤1.7, x in LiₓNa_{0.25} V₂O₅), results in the unit cell volume being expanded to 570.097 Å³ and the β angle being changed to 105.14° with lower symmetry of P2/m space group. This regime corresponds to Li-ions occupying the remaining complement of β sites between the Na-ions.^{29,30} During charging, the lithiated structure readily reverts from P2/m to C2/m space group and then finally back to the pristine structure of β-Na_{0.25}V₂O₅ at 4.0 V illustrating complete reversibility and preservation of the 1D rigid tunnel framework.

For β-K_{0.27}V₂O₅, during initial discharge to 3.15 V (0<x≤0.3), the lithiated β-K_{0.27} V₂O₅ structure retains its structure with only minimal changes as Li-ions are inserted into β′ sites. With further lithiation down to 2.60 V (0.3<x<0.8), a splitting of the 001 reflection is observed, indicating a reduction in symmetry to a P2/m space group with expansion of the unit cell from 535.913 to 560.744 Å3 as inserted Li-ions begin to fill β sites between pre-intercalated K-ions. With still further Li-ion intercalation down to 2.0 V, the volume of lithiated β-K_{0.27}V₂O₅ structure is slightly shrink to 555.402 Å³ and the symmetry of the unit cell is reduced still further to P21 space group. Consistent with FIG. 3B and FIG. 11, the stoichiometry corresponds to filling to β′, C, and β sites and perhaps additional sites that become available as a result of tunnel expansion. Similar to β-Na_{0.25}V₂O₅, the lithiated structure reverts to P2/m, C2/m space group and then to the pristine β-K_{0.27}V₂O₅ during the charging process illustrating complete preservation of the 1D tunnel framework.

β-K_{0.27}V₂O₅ shows a more expanded initial structure with a unit cell volume of 537.085 Å³ as compared to β-Na_{0.25}V₂O₅ (unit cell volume of 528.168 Å³), which is directly attributable to the larger ionic radius of K-ions. Initial lithiation of both structures results in Li-ions occupying readily available β′ sites (FIGS. 3D, 11, 4D, 4I and) and induce minimal changes in unit cell volume. The greater tunnel expansion of β-K_{0.27}V₂O₅ translates to greater Li-ion diffusivity observed during the course of lithiation (FIGS. 10A-10G). A discontinuous change in unit cell volume is observed when Li-ions begin to occupy β sites²⁹ between the pre-intercalated Na- and K-ions and is clearly discernible in discharge curves. For both β-Na_{0.25}V₂O₅ and β-K_{0.27}V₂O₅, lithiation/delithiation process is completely reversible with preservation of tunnel framework.^{34,55} In the latter compound, a series of lower symmetry structures become accessible upon increasing lithiation likely as a result of new sites that become accessible in the expanded tunnel. While pre-intercalated Na- and K-ions occupy a fraction of sites that would otherwise have been accessible for Li-ions, the expanded tunnels enable a higher accessible capacity and improved Li-ion diffusivity as compared to ζ-V₂O₅. The 1D tunnel-structured ζ-V₂O₅ framework is distinctively suitable for studying the effect of preintercalation and “pillaring” ions in electrode host structures owing to the continuous and relatively modest transformation of the V₂O₅ host lattice, where guest cations can be inserted and removed without phase transitions or framework distortions arising from substantial rearrangement of V—O bonds. It is worth noting that pre-intercalation in itself is not a universal design strategy and must be matched to the specific crystal structure motifs of an insertion host. In more rigid insertion hosts, pre-intercalation can occlude otherwise favorable diffusion pathways or increase the likelihood of framework anion migration and structural collapse by coordinative stabilization of otherwise under-coordinated adjacent anion transition sites/states.

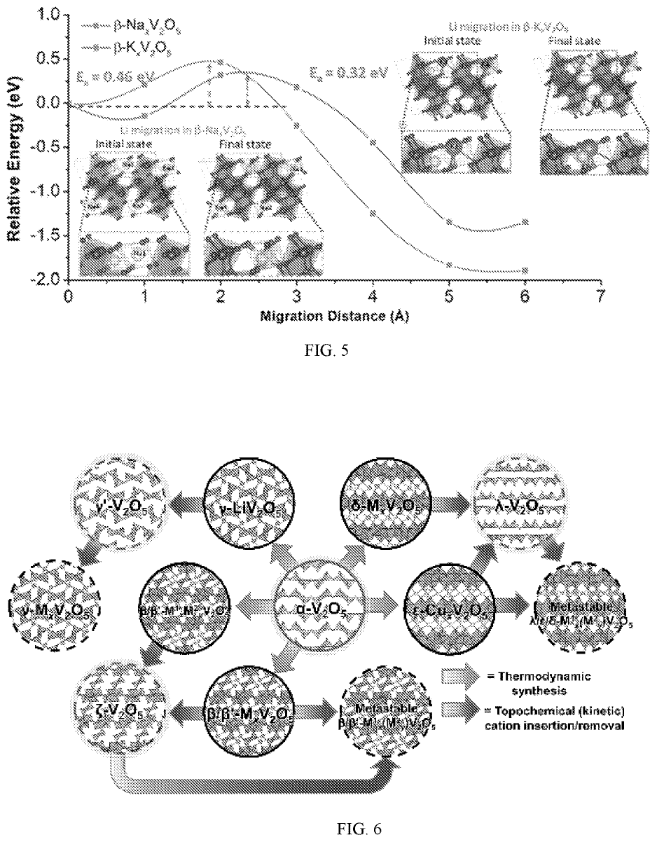

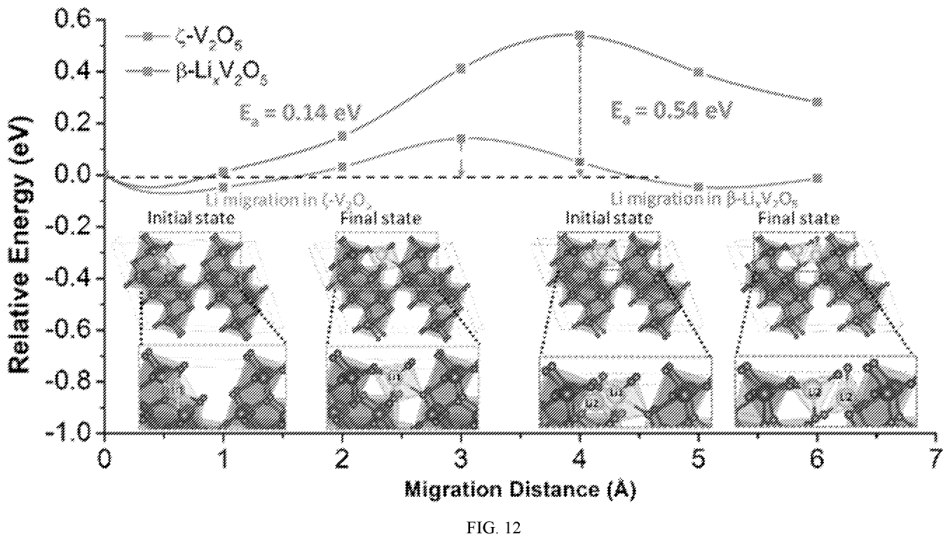

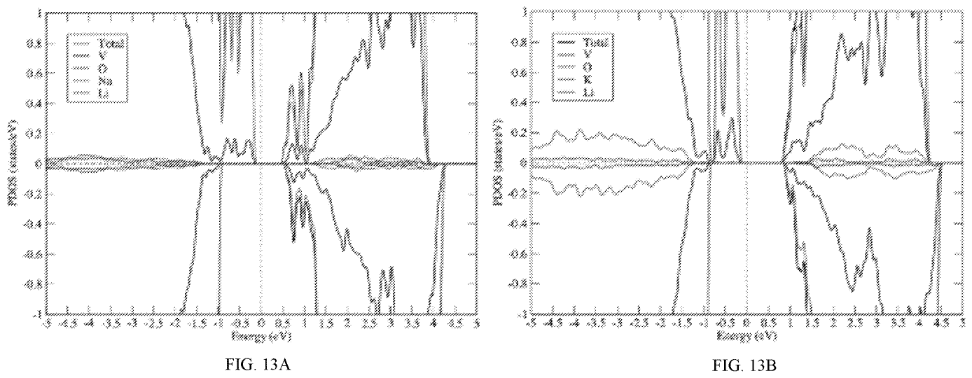

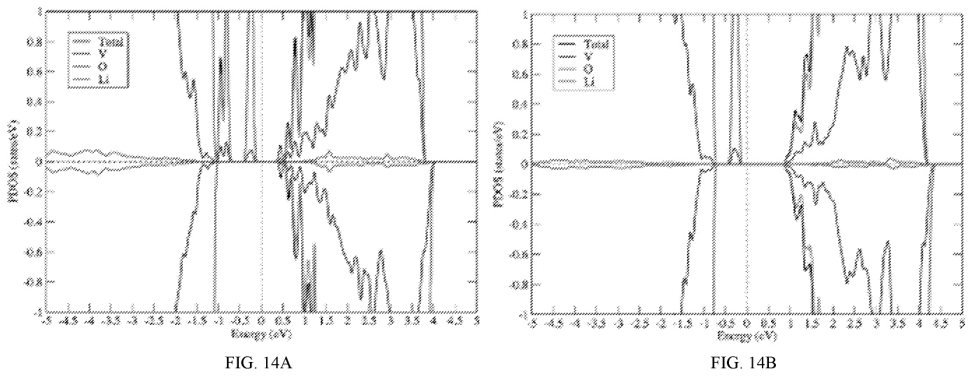

The high-resolution structure solutions of the pre-intercalated and lithiated phases enable simulations of ion migration in the framework of density functional theory (DFT). Li-ion migration barriers have been calculated based on the climbing image nudged elastic band (CI-NEB) approach. FIG. 5 sketches the Li-ion migration pathway in pre-intercalated NaₓV₂O₅ and KₓV₂O₅ along the crystallographic b direction, which corresponds to activation energy barriers of 0.46 and 0.32 eV, respectively. These results are concordant with greater Li-ion diffusivities measured in β-KₓV₂O₅ as compared to β-NaₓV₂O₅. The simulations are furthermore entirely consistent with the Li and Na site preferences across different sides of the 1D V₂O₅ tunnel. A lower activation energy barrier for Li-ion diffusion in β-KₓV₂O₅ is attributable to the greater size of K-ions as compared to Na-ions, which leads to substantially greater tunnel expansion upon pre-intercalation. FIG. 12 shows a comparison with empty ζ-V₂O₅ and β-LiₓV₂O₅ respectively. The barrier to Li-ion migration in “empty” ζ-V₂O₅ is only ca. 0.14 eV, whereas for a relatively filled tunnel, the migration barrier rises to ca. 0.54 eV. FIGS. 13A-13B and 14A-14B plot total and projected density of states of the systems under consideration. Pre-intercalation results in vanadium reduction, which gives to polaronic states at the top of the valence band—such states further enhance electrical conductivity as compared to the “empty” ζ-V₂O₅ polymorph.

In conclusion, a combination of (a) topochemical lithiation tracked by single-crystal diffraction and (b) operando synchrotron powder XRD evaluation of electrochemical lithiation of pre-intercalated β-Na_{0.25}V₂O₅ and β-K_{0.27}V₂O₅ provides mechanistic understanding of the structural role of pre-intercalation in providing access to a higher reversible capacity and improved Li-ion diffusivity. The pre-intercalated alkali-metal ions occupy β sites within expanded tunnels, this tunnel expansion alleviates repulsive Coulombic interactions amongst inserted Li-ions and yields more expansive transition states for site-to-site Li-ion diffusion. Pre-intercalation with Na-ions results in remarkable segregation of Na- and Li-ions across opposite sides of the tunnel. Individual “lanes” are not observed upon K-ion pre-intercalation wherein Li-ion migration nevertheless proceeds with high selectivity towards β′ and C-sites. Whilst pre-intercalation “sacrifices” a fraction of interstitial sites that would have otherwise been occupied by Li-ions, the results demonstrate that the tunnel expansion “propping open” effect more than compensates for this by providing access to a higher reversible capacity and enabling significantly higher Li-ion diffusivity. The results demonstrate the structural basis for unlocking greater reversible capacity and enhanced Li-ion diffusivity through site-selective modification of a promising intercalation host. Future work will focus on optimization of particle geometries and design of 3D mesoscale architectures that alleviate kinetic impediments, permit more effective utilization of the active material, and thereby realize in more full measure the promise of these materials as intercalation hosts particularly with regards to capacity retention.^{9,56-58} Surface coatings, systematic alloying, and electrolyte optimization are further necessary to increase capacity retention to approach the performance of commercial positive electrode materials.

TABLE 1
Lattice parameters corresponding to each of the insertion regimes for
β-Na_{0.25}V₂O₅ and β-K_{0.27}V₂O₅ during electrochemical lithiation as deduced from
operando synchrotron XRD measurements (related in FIGs. 4A-4J).

| | x in | | Potential | | | | | | Space |
|---|---|---|---|---|---|---|---|---|---|
| | LiₓM_{y}V₂O₅ | Regime | (V) | a (Å) | b (Å) | c (Å) | β (*) | V (Å³) | group |
| β- | 0 | A | 3.66 | 15.409 | 3.609 | 10.078 | 109.541 | 528.168 | C 2/m |
| Na_{0.25}V₂O₅ | 0 < x ≤ 0.4 | B | 3.66-3.06 | 15.358 | 3.627 | 10.158 | 109.639 | 532.956 | C 2/m |
| | 0.4 < x ≤ | C | 3.06-2.53 | 15.358 | 3.627 | 10.158 | 109.639 | 532.956 | C 2/m |
| | 0.8 | | | 15.330 | 3.674 | 10.312 | 112.218 | 537.734 | C 2/m |
| | 0.8 < x ≤ | D | 2.53-2.0 | 15.330 | 3.674 | 10.312 | 112.218 | 537.734 | C 2/m |
| | 1.7 | | | 15.189 | 3.881 | 10.017 | 105.14 | 570.097 | P 2/m |
| β-K_{0.27}V₂O₅ | 0 | A′ | 3.63 | 15.608 | 3.612 | 10.093 | 109.302 | 537.085 | C 2/m |
| | 0 < x ≤ 0.3 | B′ | 3.63-3.15 | 15.660 | 3.617 | 10.118 | 110.740 | 535.913 | C 2/m |
| | 0.3 < x ≤ | C′ | 3.15-2.60 | 15.660 | 3.617 | 10.118 | 110.740 | 535.913 | C 2/m |
| | 0.8 | | | 14.945 | 3.942 | 9.921 | 106.379 | 560.744 | P 2/m |
| | 0.8 < x≤ | D′ | 2.60-2.0 | 14.945 | 3.942 | 9.921 | 106.379 | 560.744 | P 2/m |
| | 1.7 | | | 15.627 | 3.703 | 9851 | 103.05 | 555.402 | P 21 |

TABLE 2
Crystal data and structure refinement for
β-Na_{0.32}V₂O₅: bNaV2O5_751_0m_{—}
a. CSD deposition # 2150932.

| Identification code | bNaV2O5_751_0m_a | |
|---|---|---|
| Empirical formula | Na0.32 O5 V2 | |
| Formula weight | 189.18 | |
| Temperature | 110(2) K | |
| Wavelength | 0.71073 Å | |
| Crystal system | Monoclinic | |
| Space group | C 2/m | |
| Unit cell dimensions | a = 15.3629(7) Å | α = 90°. |
| | b = 3.6109(2) Å | β = 109.5900(10)°. |
| | c = 10.0502(5) Å | γ = 90°. |

| | |
|---|---|
| Volume | 525.25(5) Å₃ |
| Z | 4 |
| Density (calculated) | 3.589 Mg/m₃ |
| Absorption coefficient | 5.254 mm₋₁ |
| F(000) | 537 |
| Crystal size | 0.290 × 0.055 × 0.030 mm₃ |
| Theta range for data collection | 2.914 to 40.047°. |
| Index ranges | −26 <= h <= 27, −6 <= k <= |
| | 6, −18 <= l <= 17 |
| Reflections collected | 13959 |
| Independent reflections | 1729 [R(int) = 0.0358] |
| Completeness to theta = 25.242° | 98.20% |
| Absorption correction | Semi-empirical from equivalents |
| Max. and min. transmission | 0.7479 and 0.5119 |
| Refinement method | Full-matrix least-squares on F₂ |
| Data / restraints / parameters | 1729 / 0 / 73 |
| Goodness-of-fit on F² | 1.074 |
| Final R indices [I > 2sigma(I)] | R1 = 0.0163, wR2 = 0.0412 |
| R indices (all data) | R1 = 0.0191, wR2 = 0.0424 |
| Extinction coefficient | 0.0285(11) |
| Largest diff. peak and hole | 0.718 and −0.761 e · Å₋₃ |

TABLE 3
Atomic coordinates (×10⁴), occupancies, and equivalent
isotropic displacement parameters (Å² × 10³) for β-Na_{0.32}V₂P₅:
bNaV2O5_751_0m_a. U(eq) is defined as one third of
the trace of the orthogonalized U^{ij} tensor.

| Atom | X | Y | z | Occupancy | Uiso |
|---|---|---|---|---|---|
| V(1) | 7120(1) | 10000 | 902(1) | 1 | 4(1) |
| V(2) | 6623(1) | 10000 | 4001(1) | 1 | 4(1) |
| V(3) | 6165(1) | 5000 | 6198(1) | 1 | 5(1) |
| Na(1) | 5014(1) | 5000 | 9031(1) | 0.477 | 10(1) |
| O(1) | 6017(1) | 10000 | 289(1) | 1 | 8(1) |
| O(2) | 7431(1) | 5000 | 744(1) | 1 | 6(1) |
| O(3) | 7367(1) | 10000 | 2767(1) | 1 | 5(1) |
| O(4) | 5629(1) | 10000 | 2810(1) | 1 | 9(1) |
| O(5) | 6858(1) | 5000 | 4453(1) | 1 | 6(1) |
| O(6) | 6340(1) | 10000 | 5786(1) | 1 | 5(1) |
| O(7) | 5000 | 5000 | 5000 | 1 | 7(1) |
| O(8) | 6066(1) | 5000 | 7737(1) | 1 | 7(1) |

TABLE 4
Anisotropic displacement parameters (Å²x 10³) for
β-Na_{0.32}V₂O₅: bNaV2O5_751_0m_a.
The anisotropic displacement factor exponent takes the form: −2π²[h²
a*²U¹¹ + . . . + 2 h k a* b* U¹²]

| Atom | U11 | U22 | U33 | U23 | U13 | U12 |
|---|---|---|---|---|---|---|
| V(1) | 5(1) | 3(1) | 4(1) | 0 | 2(1) | 0 |
| V(2) | 4(1) | 3(1) | 4(1) | 0 | 1(1) | 0 |
| V(3) | 7(1) | 3(1) | 5(1) | 0 | 3(1) | 0 |
| Na(1) | 10(1) | 10(1) | 11(1) | 0 | 3(1) | 0 |
| O(1) | 6(1) | 12(1) | 7(1) | 0 | 1(1) | 0 |
| O(2) | 9(1) | 4(1) | 6(1) | 0 | 4(1) | 0 |
| O(3) | 5(1) | 5(1) | 5(1) | 0 | 2(1) | 0 |
| O(4) | 5(1) | 16(1) | 6(1) | 0 | 1(1) | 0 |
| O(5) | 7(1) | 5(1) | 7(1) | 0 | 3(1) | 0 |
| O(6) | 6(1) | 5(1) | 5(1) | 0 | 2(1) | 0 |
| O(7) | 5(1) | 6(1) | 9(1) | 0 | 1(1) | 0 |
| O(8) | 8(1) | 8(1) | 6(1) | 0 | 3(1) | 0 |

TABLE 5
Crystal data and structure refinement for
β-K_{0.22}V₂O₅: KV2O5_61001_0m_a.
CSD deposition # 2150933.

| Identification code | KV2O5_61001_0m_a | |
|---|---|---|
| Empirical formula | K0.22 O5 V2 | |
| Formula weight | 190.38 | |
| Temperature | 110(2) K | |
| Wavelength | 0.71073 Å | |
| Crystal system | Monoclinic | |
| Space group | C 2/m | |
| Unit cell dimensions | a = 15.4753(10) Å | α = 90°. |
| | b = 3.6123(2) Å | β = 109.357(2)°. |
| | c = 10.0693(6) Å | γ = 90°. |

| | |
|---|---|
| Volume | 531.07(6) Å₃ |
| Z | 4 |
| Density (calculated) | 3.572 Mg/m₃ |
| Absorption coefficient | 5.413 mm₋₁ |
| F(000) | 541 |
| Crystal size | 0.140 × 0.025 × 0.010 mm₃ |
| Theta range for data collection | 2.144 to 41.426°. |
| Index ranges | −28 <= h <= 28, −6 <= k <= |
| | 6, −18 <= l <= 18 |
| Reflections collected | 14296 |
| Independent reflections | 1990 [R(int) = 0.0644] |
| Completeness to theta = 25.242° | 99.50% |
| Absorption correction | Semi-empirical from equivalents |
| Max. and min. transmission | 0.3508 and 0.2619 |
| Refinement method | Full-matrix least-squares on F₂ |
| Data / restraints / parameters | 1990 / 0 / 73 |
| Goodness-of-fit on F² | 1.072 |
| Final R indices [I > 2sigma(I)] | R1 = 0.0368, wR2 = 0.0829 |
| R indices (all data) | R1 = 0.0580, wR2 = 0.0969 |
| Extinction coefficient | 0.0075(10) |
| Largest diff. peak and hole | 1.542 and −1.379 e · Å₋₃ |

TABLE 6
Atomic coordinates (×10⁴), occupancies, and equivalent
isotropic displacement parameters (Å² × 10³) for β-K_{0.22}V₂O₅:
KV2O5_61001_0m_a. U(eq) is defined as one third of
the trace of the orthogonalized U^{ij} tensor.

| Atom | X | Y | z | Occupancy | Uiso |
|---|---|---|---|---|---|
| V(1) | 3840(1) | 5000 | 3826(1) | 1 | 7(1) |
| V(2) | 3367(1) | 10000 | 6004(1) | 1 | 6(1) |
| V(3) | 2853(1) | 10000 | 9075(1) | 1 | 8(1) |
| K(1) | 4999(2) | 5000 | 10800(3) | 0.324 | 22(1) |
| O(1) | 3929(1) | 5000 | 2285(2) | 1 | 10(1) |
| O(2) | 5000 | 5000 | 5000 | 1 | 10(1) |
| O(3) | 3662(1) | 10000 | 4231(2) | 1 | 7(1) |
| O(4) | 3140(1) | 5000 | 5551(2) | 1 | 8(1) |
| O(5) | 4350(1) | 10000 | 7180(2) | 1 | 10(1) |
| O(6) | 2620(1) | 10000 | 7216(2) | 1 | 7(1) |
| O(7) | 2552(2) | 5000 | 9243(2) | 1 | 12(1) |
| O(8) | 3937(2) | 10000 | 9682(2) | 1 | 21(1) |

TABLE 7
Anisotropic displacement parameters (Å²x 10³) for
β-K_{0.22}V₂O₅: KV2O5_61001_0m_a. The anisotropic displacement factor
exponent takes the form: −2π²[h² a*²U¹¹ + . . . + 2 h k a* b* U¹²]

| Atom | U11 | U22 | U33 | U23 | U13 | U12 |
|---|---|---|---|---|---|---|
| V(1) | 11(1) | 4(1) | 8(1) | 0 | 5(1) | 0 |
| V(2) | 7(1) | 5(1) | 6(1) | 0 | 2(1) | 0 |
| V(3) | 11(1) | 6(1) | 6(1) | 0 | 4(1) | 0 |
| K(1) | 14(1) | 13(1) | 35(1) | 0 | 4(1) | 0 |
| O(1) | 11(1) | 11(1) | 9(1) | 0 | 4(1) | 0 |
| O(2) | 10(1) | 8(1) | 10(1) | 0 | 2(1) | 0 |
| O(3) | 10(1) | 6(1) | 7(1) | 0 | 4(1) | 0 |
| O(4) | 9(1) | 6(1) | 9(1) | 0 | 4(1) | 0 |
| O(5) | 8(1) | 13(1) | 9(1) | 0 | 2(1) | 0 |
| O(6) | 9(1) | 6(1) | 8(1) | 0 | 3(1) | 0 |
| O(7) | 25(1) | 6(1) | 10(1) | 0 | 11(1) | 0 |
| O(8) | 12(1) | 39(1) | 11(1) | 0 | 2(1) | 0 |

TABLE 8
Rietveld refinement statistics and atom coordinates for β-Na_{0.25}V₂O₅.
Related to FIG. 1B. Atom positions, fractional occupancies, and
thermal parameters obtained from refinement of the diffraction
pattern measured for β-Na_{0.25}V₂O₅. Refinement statistics and
lattice parameters are included in the table header.
a = 15.408(8) Å, b = 3.609(1) Å, c = 10.077(9) Å,
α = 90°, β = 109.541°, γ = 90°
Volume = 528.167 Å³; Space group C 2/m

| Atom | | | | | |
|---|---|---|---|---|---|
| Label | X | Y | z | Uiso*100 | Occupancy |
| Na1 | 0.9899(1) | 0.0000(0) | 0.3997(8) | 0.024 | 0.37(8) |
| V1 | 0.3391(3) | 0.0000(0) | 0.1031(4) | 0.009 | 1.00(0) |
| V2 | 0.1161(1) | 0.0000(0) | 0.1174(3) | 0.007 | 1.00(0) |
| V3 | 0.2884(7) | 0.0000(0) | 0.4098(5) | 0.011 | 1.00(0) |
| O1 | 0.0000(0) | 0.0000(0) | 0.0000(0) | 0.015 | 1.00(0) |
| O2 | 0.8159(8) | 0.0000(0) | 0.0502(7) | 0.010 | 1.00(0) |
| O3 | 0.6261(4) | 0.0000(0) | 0.0752(8) | 0.011 | 1.00(0) |
| O4 | 0.4365(2) | 0.0000(0) | 0.2236(6) | 0.019 | 1.00(0) |
| O5 | 0.2659(0) | 0.0000(0) | 0.2290(2) | 0.017 | 1.00(0) |
| O6 | 0.1090(4) | 0.0000(0) | 0.2751(1) | 0.015 | 1.00(0) |
| O7 | 0.7527(5) | 0.0000(0) | 0.4278(8) | 0.016 | 1.00(0) |
| O8 | 0.3987(2) | 0.0000(0) | 0.4732(4) | 0.026 | 1.00(0) |

TABLE 9
Rietveld refinement statistics and atom coordinates for β-K_{0.27}V₂O₅.
Related to FIG. 1E. Atom positions, fractional occupancies, and
thermal parameters obtained from refinement of the diffraction
pattern measured for β-Na_{0.27}V₂O₅. Refinement statistics and
lattice parameters are included in the table header.
a = 15.608(2) Å, b = 3.612(1) Å, c = 10.092(9) Å,
α = 90°, β = 109.302°, γ = 90°
Volume = 537.085 Å³; Space group C 2/m

| Atom | | | | | |
|---|---|---|---|---|---|
| Label | X | Y | z | Uiso*100 | Occupancy |
| K1 | 0.9823(3) | 0.0000(0) | 0.4180(1) | 0.023 | 0.39(1) |
| V1 | 0.3167(7) | 0.0000(0) | 0.0809(7) | 0.087 | 1.00(0) |
| V2 | 0.1151(0) | 0.0000(0) | 0.1114(2) | 0.036 | 1.00(0) |
| V3 | 0.2729(1) | 0.0000(0) | 0.3730(5) | 0.092 | 1.00(0) |
| O1 | 0.0000(0) | 0.0000(0) | 0.0000(0) | 0.813 | 1.00(0) |
| O2 | 0.8276(4) | 0.0000(0) | 0.0410(9) | 0.002 | 1.00(0) |
| O3 | 0.6158(0) | 0.0000(0) | 0.0740(3) | 0.019 | 1.00(0) |
| O4 | 0.4221(6) | 0.0000(0) | 0.1988(9) | 0.045 | 1.00(0) |
| O5 | 0.2209(5) | 0.0000(0) | 0.1790(4) | 0.053 | 1.00(0) |
| O6 | 0.4039(9) | 0.0000(0) | 0.2280(3) | 0.013 | 1.00(0) |
| O7 | 0.7527(6) | 0.0000(0) | 0.4170(4) | 0.029 | 1.00(0) |
| O8 | 0.3987(7) | 0.0000(0) | 0.4860(7) | 0.056 | 1.00(0) |

TABLE 10
Calculated Li-ion diffusion coefficients of ζ-
V₂O₅, β-Na_{0.25}V₂O₅ and β-K_{0.27}V₂O₅ in different
intercalation regimes based on Randles-Sevcik analysis.

| | Lithiation/ | D_{Li+} in | D_{Li+} in β- | D_{Li+} in β- |
|---|---|---|---|---|
| | Delithiation | ζ-V₂O₅ | Na_{0.25}V₂O₅ | K_{0.27} V₂ O₅ |
| | State | (cm²/s) | (cm²/s) | (cm² /s) |
| Reduction | I | 2.23 × 10⁻⁹ | 1.64 × 10⁻⁸ | 1.10 × 10⁻⁷ |
| | II | 4.27 × 10⁻¹¹ | 1.72 × 10⁻¹⁰ | 3.08 × 10⁻⁹ |
| | III | 3.22 × 10⁻¹² | 6.61 × 10⁻¹² | 1.15 × 10⁻¹⁰ |
| Oxidation | I′ | 5.16 × 10⁻⁹ | 1.98 × 10⁻⁸ | 3.63 × 10⁻⁷ |
| | II′ | 8.43 × 10⁻¹¹ | 1.53 × 10⁻¹⁰ | 4.08 × 10⁻⁹ |
| | III′ | 3.44 × 10⁻¹² | 1.15 × 10⁻¹¹ | 1.32 × 10⁻¹⁰ |

TABLE 11
Crystal data and structure refinement for β-
Na_{0.32}/B′-Li_{0.33}V₂O₅: NaV2O5_02MLi_6951A_{—}
0m_a. CSD deposition # 2150934.

| Identification code | NaV2O5_02MLi_6951A_0m_a | |
|---|---|---|
| Empirical formula | Li0.33 Na0.32 O5 V2 | |
| Formula weight | 190.81 | |
| Temperature | 110(2) K | |
| Wavelength | 0.71073 Å | |
| Crystal system | Monoclinic | |
| Space group | P 21/m | |
| Unit cell dimensions | a = 10.1482(3) Å | α = 90°. |
| | b = 3.63080(10) Å | β = |
| | | 109.2140(10)°. |
| | c = 15.2420(4) Å | γ = 90°. |

| | |
|---|---|
| Volume | 530.32(3) Å₃ |
| Z | 4 |
| Density (calculated) | 3.585 Mg/m₃ |
| Absorption coefficient | 5.201 mm₋₁ |
| F(000) | 541 |
| Crystal size | 0.120 × 0.050 × 0.020 mm₃ |
| Theta range for data collection | 2.125 to 54.068°. |
| Index ranges | −22 <= h <= 23, −8 <= k <= |
| | 8, −34 <= l <= 34 |
| Reflections collected | 63786 |
| Independent reflections | 7147 [R(int) = 0.0452] |
| Completeness to theta = 25.242° | 98.50% |
| Absorption correction | Semi-empirical from equivalents |
| Max. and min. transmission | 0.3666 and 0.2662 |
| Refinement method | Full-matrix least-squares on F₂ |
| Data / restraints / parameters | 7147 / 0 / 141 |
| Goodness-of-fit on F² | 1.228 |
| Final R indices [I > 2sigma(I)] | R1 = 0.0472, wR2 = 0.0767 |
| R indices (all data) | R1 = 0.0533, wR2 = 0.0784 |
| Extinction coefficient | 0.0042(7) |
| Largest diff. peak and hole | 2.929 and −2.494 e · Å₋₃ |

TABLE 12
Atomic coordinates (×10⁴), occupancies, and equivalent isotropic
displacement parameters (Å² × 10³) for β-Na_{0.32}/β′-
Li_{0.33}V₂O₅: NaV2O5_02MLi_6951A_0m_a. U(eq) is defined
as one third of the trace of the orthogonalized U^{ij} tensor.

| Atom | x | Y | z | Occupancy | Uiso |
|---|---|---|---|---|---|
| V(1) | −3746(1) | 2500 | 396(1) | 1 | 4(1) |
| V(2) | −132(1) | 2500 | 872(1) | 1 | 4(1) |
| V(3) | 2490(1) | 7500 | 1243(1) | 1 | 4(1) |
| V(4) | 2583(1) | 7500 | 3631(1) | 1 | 3(1) |
| V(5) | 5167(1) | 12500 | 4126(1) | 1 | 4(1) |
| V(6) | 8733(1) | 12500 | 4657(1) | 1 | 4(1) |
| Na(1) | 6464(1) | 7500 | 2523(1) | 0.863 | 9(1) |
| O(1) | −4180(1) | −2500 | 71(1) | 1 | 6(1) |
| O(2) | −3264(2) | 2500 | 1513(1) | 1 | 8(1) |
| O(3) | −2088(1) | 2500 | 157(1) | 1 | 5(1) |
| O(4) | −274(1) | 2500 | 1892(1) | 1 | 7(1) |
| O(5) | 111(1) | −2500 | 633(1) | 1 | 5(1) |
| O(6) | 1946(1) | 2500 | 1168(1) | 1 | 5(1) |
| O(7) | 4146(1) | 7500 | 1410(1) | 1 | 7(1) |
| O(8) | 2486(2) | 7500 | 2506(1) | 1 | 6(1) |
| O(9) | 914(1) | 7500 | 3592(1) | 1 | 7(1) |
| O(10) | 3091(1) | 12500 | 3854(1) | 1 | 5(1) |
| O(11) | 4826(1) | 7500 | 4324(1) | 1 | 6(1) |
| O(12) | 5333(1) | 12500 | 3107(1) | 1 | 8(1) |
| O(13) | 7035(1) | 12500 | 4831(1) | 1 | 6(1) |
| O(14) | 8267(1) | 12500 | 3524(1) | 1 | 8(1) |
| O(15) | 9191(1) | 7500 | 5005(1) | 1 | 7(1) |
| Li(1) | 26(5) | 2500 | 3218(3) | 1 | 14(1) |

TABLE 13
Anisotropic displacement parameters (Å²x 10³) for
β-Na_{0.32}/β′-Li_{0.33}V₂O₅: NaV2O5_02MLi_6951A_0m_a.
The anisotropic displacement factor exponent takes the form: −2π²[h²
a*²U¹¹ + . . . + 2 h k a* b* U¹²].

| Atom | U11 | U22 | U33 | U23 | U13 | U12 |
|---|---|---|---|---|---|---|
| V(1) | 4(1) | 3(1) | 5(1) | 0 | 2(1) | 0 |
| V(2) | 5(1) | 3(1) | 4(1) | 0 | 2(1) | 0 |
| V(3) | 4(1) | 2(1) | 5(1) | 0 | 2(1) | 0 |
| V(4) | 4(1) | 3(1) | 4(1) | 0 | 2(1) | 0 |
| V(5) | 5(1) | 3(1 | 5(1) | 0 | 2(1) | 0 |
| V(6) | 4(1) | 3(1) | 5(1) | 0 | 2(1) | 0 |
| Na(1) | 11(1) | 7(1) | 9(1) | 0 | 3(1) | 0 |
| O(1) | 5(1) | 4(1) | 9(1) | 0 | 2(1) | 0 |
| O(2) | 8(1) | 10(1) | 5(1) | 0 | 2(1) | 0 |
| O(3) | 4(1) | 6(1) | 5(1) | 0 | 2(1) | 0 |
| O(4) | 8(1) | 8(1) | 6(1) | 0 | 3(1) | 0 |
| O(5) | 6(1) | 4(1) | 7(1) | 0 | 2(1) | 0 |
| O(6) | 5(1) | 4(1) | 6(1) | 0 | 2(1) | 0 |
| O(7) | 5(1) | 8(1) | 9(1) | 0 | 2(1) | 0 |
| O(8) | 9(1) | 6(1) | 4(1) | 0 | 2(1) | 0 |
| O(9) | 6(1) | 6(1) | 9(1) | 0 | 3(1) | 0 |
| O(10) | 5(1) | 4(1) | 6(1) | 0 | 2(1) | 0 |
| O(11) | 7(1) | 4(1) | 7(1) | 0 | 2(1) | 0 |
| O(12) | 7(1) | 10(1) | 6(1) | 0 | 2(1) | 0 |
| O(13) | 6(1) | 5(1) | 6(1) | 0 | 2(1) | 0 |
| O(14) | 7(1) | 12(1) | 5(1) | 0 | 2(1) | 0 |
| O(15) | 6(1) | 4(1) | 11(1) | 0 | 3(1) | 0 |
| Li(1) | 16(2) | 13(2) | 16(2) | 0 | 9(2) | 0 |

TABLE 14
ICP-MS information for topochemically treated crystals. Listed are
the molecular formula of the solved topochemical single-crystal structure
in this study; Raw analyte concentrations of a bulk sample of these crystals
for Li⁷, Na²³, V⁵¹ as collected on a PerkinElmer NexION 300D ICP-MS
instrument using a Sc⁴⁵ internal standard; and molar ratios for Li and Na to
V₂ calculated from these concentrations.

| Refined Single- | Analyte Concentrations (ng/mL)^{1, 2} | | | Molar Ratios | |
|---|---|---|---|---|---|
| Crystal Formula | Li⁷ | Na | V | Li:V₂ | Na:V₂ |
| Na_{0.32}Li_{0.33}V₂O₅ | 0.38 | 0.87 | 15.1 | 0.36 | 0.25 |

¹Samples were prepared for ICP-MS by digesting 1-2 mg of topochemically-treated single-crystals in concentrated nitric acid, then diluting in Milli-Q-purified H₂O until estimated concentrations were in a suitable (ca. 1-100 ppb) range.
²Estimated relative uncertainties are 5%

TABLE 15
Crystal data and structure refinement for β-K_{0.22}/β′-Li_{0.23} V₂O₅:
b-LixKyV2O5_25I4-1B-1. CSD deposition # 2203830.

| Identification code | B-LixKyV2O5_25I4-1B-1 | |
|---|---|---|
| Empirical formula | K0.22 Li0.23 O5 V2 | |
| Formula weight | 191.97 | |
| Temperature | 110.(0) K | |
| Wavelength | 0.71073 Å | |
| Crystal system | Monoclinic | |
| Space group | C 2/m | |
| Unit cell dimensions | a = 15.4000(6) Å | α = 90°. |
| | b = 3.62390(10) Å | β = |
| | | 109.6960(10)°. |
| | c = 10.1278(3) Å | γ = 90°. |

| | |
|---|---|
| Volume | 532.14(3) Å₃ |
| Z | 6 |
| Density (calculated) | 3.594 Mg/m₃ |
| Absorption coefficient | 5.401 mm₋₁ |
| F(000) | 545 |
| Crystal size | 0.105 × 0.084 × 0.027 mm₃ |
| Theta range for data collection | 2.900 to 55.889°. |
| Index ranges | −35 <= h <= 35, −8 <= k <= |
| | 8, −23 <= l <= 23 |
| Reflections collected | 38478 |
| Independent reflections | 3824 [R(int) = 0.0660] |
| Completeness to theta = 25.242° | 98.40% |
| Absorption correction | Semi-empirical from equivalents |
| Max. and min. transmission | 0.7510 and 0.6173 |
| Refinement method | Full-matrix least-squares on F₂ |
| Data / restraints / parameters | 3824 / 0 / 80 |
| Goodness-of-fit on F² | 1.105 |
| Final R indices [I > 2sigma(I)] | R1 = 0.0247, wR2 = 0.0473 |
| R indices (all data) | R1 = 0.0317, wR2 = 0.0497 |
| Extinction coefficient | 0.0050(5) |
| Largest diff. peak and hole | 1.124 and −1.656 e · Å₋₃ |

TABLE 16
Atomic coordinates (×10⁴), occupancies, and equivalent
isotropic displacement parameters (Å² × 10³) for β-K_{0.22}/β′-
Li_{0.23}V₂O₅: β-LixKyV2O5_25I4-1B-1. U(eq) is defined
as one third of the trace of the orthogonalized U^{ij} tensor.

| Atom | x | y | z | Occupancy | Uiso |
|---|---|---|---|---|---|
| V(1) | 6182.3(2) | 5000 | 6156.2(2) | 1 | 6.33(2) |
| V(2) | 6631.2(2) | 10000 | 3990.5(2) | 1 | 3.42(2) |
| V(3) | 7136.7(2) | 10000 | 906.7(2) | 1 | 4.33(2) |
| K(1) | 4981.9(7) | 5000 | 9011.8(13) | 0.326(2) | 21.7(2) |
| O(1) | 6086.5(5) | 5000 | 7710.2(7) | 1 | 7.32(9) |
| O(2) | 5000 | 5000 | 5000 | 1 | 6.61(12) |
| O(3) | 6339.8(5) | 10000 | 5764.3(7) | 1 | 4.79(8) |
| O(4) | 6855.6(5) | 5000 | 4477.3(7) | 1 | 5.76(8) |
| O(5) | 5628.0(5) | 10000 | 2805.1(8) | 1 | 8.18(9) |
| O(6) | 7353.2(5) | 10000 | 2772.2(7) | 1 | 4.85(8) |
| O(7) | 6026.4(6) | 10000 | 260.8(9) | 1 | 12.35(13) |
| O(8) | 7455.2(6) | 5000 | 767.2(8) | 1 | 7.83(10) |
| Li(1) | 4324.(5) | 10000 | 1805.(7) | 0.351(14) | 11.7(16) |

TABLE 17
Anisotropic displacement parameters (Å²x 10³)
for β-K_{0.22}/β'-Li_{0.23}V₂O₅: b-LixKyV2O5_25I4-1B-
1. The anisotropic displacement factor exponent takes the form: −2π²[
h² a*²U¹¹ + . . . + 2 h k a* b* U¹²]

| Atom | U11 | U22 | U33 | U23 | U13 | U12 |
|---|---|---|---|---|---|---|
| V(1) | 10.78(5) | 2.24(4) | 8.59(5) | 0 | 6.70(4) | 0 |
| V(2) | 4.21(4) | 2.37(4) | 3.65(4) | 0 | 1.27(3) | 0 |
| V(3) | 6.34(5) | 3.12(4) | 4.31(4) | 0 | 2.84(3) | 0 |
| K(1) | 15.8(4) | 14.6(3) | 30.9(5) | 0 | 2.9(3) | 0 |
| O(1) | 8.7(2) | 5.8(2) | 5.5(2) | 0 | 3.44(18) | 0 |
| O(2) | 4.6(3) | 4.8(3) | 9.6(3) | 0 | 1.2(2) | 0 |
| O(3) | 6.8(2) | 3.31(17) | 4.62(18) | 0 | 2.44(16) | 0 |
| O(4) | 7.4(2) | 3.65(17) | 6.7(2) | 0 | 2.97(17) | 0 |
| O(5) | 5.7(2) | 11.6(3) | 6.4(2) | 0 | 1.01(17) | 0 |
| O(6) | 5.81(19) | 4.59(18) | 4.31(18) | 0 | 1.89(15) | 0 |
| O(7) | 7.3(2) | 21.6(4) | 7.7(2) | 0 | 2.0(2) | 0 |
| O(8) | 15.3(3) | 3.73(18) | 7.0(2) | 0 | 7.1(2) | 0 |
| Li(1) | 14.(3) | 10.(3) | 7.(2) | 0 | −2.0(19) | 0 |

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated within the scope of the invention without limitation thereto.

### REFERENCES

(1) Cano, Z. P.; Banham, D.; Ye, S.; Hintennach, A.; Lu, J.; Fowler, M.; Chen, Z. Batteries and Fuel Cells for Emerging Electric Vehicle Markets. Nat. Energy 2018, 3 (4), 279-289. https://doi.org/10.1038/s41560-018-0108-1.
(2) Goodenough, J. B.; Park, K. S. The Li-Ion Rechargeable Battery: A Perspective. J. Am. Chem. Soc. 2013, 135 (4), 1167-1176. https://doi.org/10.1021/ja3091438.
(3) Whittingham, M. S. Lithium Batteries: 50 Years of Advances to Address the Next 20 Years of Climate Issues. Nano Letters. American Chemical Society Dec. 9, 2020, pp 8435-8437. https://doi.org/10.1021/acs.nanolett.0c04347.
(4) Jin, Y.; Liu, K.; Lang, J.; Zhuo, D.; Huang, Z.; Wang, C.; Wu, H.; Cui, Y. An Intermediate Temperature Garnet-Type Solid Electrolyte-Based Molten Lithium Battery for Grid Energy Storage. Nat. Energy 2018, 3 (9), 732-738. https://doi.org/10.1038/s41560-018-0198-9.
(5) Whittingham, M. S.; Siu, C.; Ding, J. Can Multielectron Intercalation Reactions Be the Basis of Next Generation Batteries? Acc. Chem. Res. 2018, 51 (2), 258-264. https://doi.org/10.1021/acs.accounts.7b00527.
(6) Kleiner, K.; Ehrenberg, H. Challenges Considering the Degradation of Cell Components in Commercial Lithium-Ion Cells: A Review and Evaluation of Present Systems BT-Electrochemical Energy Storage: Next Generation Battery Concepts; Eichel, R.-A., Ed.; Springer International Publishing: Cham, 2019; pp 169-213. https://doi.org/10.1007/978-3-030-26130-6_5.
(7) Ryan, E. M.; Mukherjee, P. P. Mesoscale Modeling in Electrochemical Devices-A Critical Perspective. Prog. Energy Combust. Sci. 2019, 71, 118-142. https://doi.org/10.1016/j.pecs.2018.11.002.
(8) Zhang, X.; Ju, Z.; Zhu, Y.; Takeuchi, K. J.; Takeuchi, E. S.; Marschilok, A. C.; Yu, G. Multiscale Understanding and Architecture Design of High Energy/Power Lithium-Ion Battery Electrodes. Adv. Energy Mater. 2021, 11 (2). https://doi.org/10.1002/aenm.202000808.
(9) Luo, Y.; Bai, Y.; Mistry, A.; Zhang, Y.; Zhao, D.; Sarkar, S.; Handy, J. V.; Rezaei, S.; Chuang, A. C.; Carrillo, L.; Wiaderek, K.; Pharr, M.; Xie, K.; Mukherjee, P. P.; Xu, B.-X.; Banerjee, S. Effect of Crystallite Geometries on Electrochemical Performance of Porous Intercalation Electrodes by Multiscale Operando Investigation. Nat. Mater. 2021 2021, 1-11. https://doi.org/10.1038/s41563-021-01151-8.
(10) Xu, R.; Zhao, K. Electrochemomechanics of Electrodes in Li-Ion Batteries: A Review. J. Electrochem. Energy Convers. Storage 2016, 13 (3), 1-9. https://doi.org/10.1115/1.4035310.
(11) Zhao, Y.; Stein, P.; Bai, Y.; Al-Siraj, M.; Yang, Y.; Xu, B. X. A Review on Modeling of Electro-Chemo-Mechanics in Lithium-Ion Batteries. J. Power Sources 2019, 413 (October 2018), 259-283. https://doi.org/10.1016/j.jpowsour.2018.12.011.
(12) Whittingham, M. S. Lithium Batteries and Cathode Materials. Chem. Rev. 2004, 104 (10), 4271-4301. https://doi.org/10.1021/cr020731c.
(13) Manthiram, A. A Reflection on Lithium-Ion Battery Cathode Chemistry. Nat. Commun. 2020, 11 (1), 1-9. https://doi.org/10.1038/s41467-020-15355-0.
(14) Bhatt, M. D.; O'Dwyer, C. Recent Progress in Theoretical and Computational Investigations of Li-Ion Battery Materials and Electrolytes. Phys. Chem. Chem. Phys. 2015, 17 (7), 4799-4844. https://doi.org/10.1039/c4cp05552g.
(15) Liu, L.; Wu, Y. C.; Huang, L.; Liu, K.; Duployer, B.; Rozier, P.; Taberna, P. L.; Simon, P. Alkali Ions Pre-Intercalated Layered MnO2 Nanosheet for Zinc-Ions Storage. Adv. Energy Mater. 2021, 11 (31). https://doi.org/10.1002/aenm.202101287.
(16) Clites, M.; Pomerantseva, E. Bilayered Vanadium Oxides by Chemical Pre-Intercalation of Alkali and Alkali-Earth Ions as Battery Electrodes. Energy Storage Mater. 2018, 11 (September 2017), 30-37. https://doi.org/10.1016/j.ensm.2017.09.005.
(17) Liu, G.; Huang, H.; Bi, R.; Xiao, X.; Ma, T.; Zhang, L. K⁺ Pre-Intercalated Manganese Dioxide with Enhanced Zn²⁺ Diffusion for High Rate and Durable Aqueous Zinc-Ion Batteries. J. Mater. Chem. A 2019, 7 (36), 20806-20812. https://doi.org/10.1039/c9ta08049j.
(18) Chernova, N. A.; Roppolo, M.; Dillon, A. C.; Whittingham, M. S. Layered Vanadium and Molybdenum Oxides: Batteries and Electrochromics. J. Mater. Chem. 2009, 19 (17), 2526-2552. https://doi.org/10.1039/b819629j.
(19) Chao, D.; Xia, X.; Liu, J.; Fan, Z.; Ng, C. F.; Lin, J.; Zhang, H.; Shen, Z. X.; Fan, H. J. A V2O5/Conductive-Polymer Core/Shell Nanobelt Array on Three-Dimensional Graphite Foam: A High-Rate, Ultrastable, and Freestanding Cathode for Lithium-Ion Batteries. Adv. Mater. 2014, 26 (33), 5794-5800. https://doi.org/10.1002/adma.201400719.
(20) Zhu, Y.; Yang, M.; Huang, Q.; Wang, D.; Yu, R.; Wang, J.; Zheng, Z.; Wang, D. V2O5 Textile Cathodes with High Capacity and Stability for Flexible Lithium-Ion Batteries. Adv. Mater. 2020, 32 (7). https://doi.org/10.1002/adma.201906205.
(21) Kumagai, N.; Tanno, K.; Nakajima, T.; Watanabe, N. Structural Changes of Nb205 and V2O5 as Rechargeable Cathodes for Lithium Battery. Electrochim. Acta 1983, 28 (1), 17-22. https://doi.org/10.1016/0013-4686 (83) 85081-6.
(22) Santos, D. A.; Dixit, M. K.; Pradeep Kumar, P.; Banerjee, S. Assessing the Role of Vanadium Technologies in Decarbonizing Hard-to-Abate Sectors and Enabling the Energy Transition. iScience 2021, 24 (11), 103277. https://doi.org/10.1016/J.ISCI.2021.103277.
(23) De Jesus, L.; Zhao, Y.; Horrocks, G. A.; Andrews, J.; Stein, P.; Xu, B.; Banerjee, S. Lithiation across Interconnected V2O5 Nanoparticle Networks. J. Mater. Chem. A 2017, 5 (38). https://doi.org/10.1039/C7TA04892K.
(24) Parija, A.; Liang, Y.; Andrews, J. L.; De Jesus, L. R.; Prendergast, D.; Banerjee, S. Topochemically De-Intercalated Phases of V2O5 as Cathode Materials for Multivalent Intercalation Batteries: A First-Principles Evaluation. Chem. Mater. 2016, 28 (16), 5611-5620. https://doi.org/10.1021/acs.chemmater.6b01006.
(25) Horrocks, G. A.; Parija, A.; De Jesus, L. R.; Wangoh, L.; Sallis, S.; Luo, Y.; Andrews, J. L.; Jude, J.; Jaye, C.; Fischer, D. A.; Prendergast, D.; Piper, L. F. J.; Banerjee, S. Mitigating Cation Diffusion Limitations and Intercalation-Induced Framework Transitions in a 1D Tunnel-Structured Polymorph of V2O5. Chem. Mater. 2017, 29 (24), 10386-10397. https://doi.org/10.1021/acs.chemmater.7b03800.
(26) De Jesus, L. R.; Andrews, J. L.; Parija, A.; Banerjee, S. Defining Diffusion Pathways in Intercalation Cathode Materials: Some Lessons from V2O5 on Directing Cation Traffic. ACS Energy Lett. 2018, 3 (4), 915-931. https://doi.org/10.1021/acsenergylett.8b00156.
(27) Luo, Y.; De Jesus, L. R.; Andrews, J. L.; Parija, A.; Fleer, N.; Robles, D. J.; Mukherjee, P. P.; Banerjee, S. Roadblocks in Cation Diffusion Pathways: Implications of Phase Boundaries for Li-Ion Diffusivity in an Intercalation Cathode Material. ACS Appl. Mater. Interfaces 2018, 10 (36), 30901-30911. https://doi.org/10.1021/acsami.8b10604.
(28) De Jesus, L. R.; Horrocks, G. A.; Liang, Y.; Parija, A.; Jaye, C.; Wangoh, L.; Wang, J.; Fischer, D. A.; Piper, L. F. J.; Prendergast, D.; Banerjee, S. Mapping Polaronic States and Lithiation Gradients in Individual V2O5 nanowires. Nat. Commun. 2016, 7 (May), 1-9. https://doi.org/10.1038/ncomms12022.
(29) Handy, J. V.; Luo, Y.; Andrews, J. L.; Bhuvanesh, N.; Banerjee, S. An Atomic View of Cation Diffusion Pathways from Single-Crystal Topochemical Transformations. Angew. Chemie Int. Ed. 2020, 59 (38), anie.202005513. https://doi.org/10.1002/anie.202005513.
(30) Luo, Y.; Rezaei, S.; Santos, D. A.; Zhang, Y.; Handy, J. V.; Carrillo, L.; Schultz, B. J.; Gobbato, L.; Pupucevski, M.; Wiaderek, K.; Charalambous, H.; Yakovenko, A.; Pharr, M.; Xu, B.-X.; Banerjee, and S. Cation Reordering Instead of Phasetransitions: Origins and Implications of Contrasting Lithiation Mechanisms in One-Dimensional (1D) ζ- and Two-Dimensional (2D) α-V2O5. Proc. Natl. Sci. https://doi.org/10.1073/pnas.2115072119.
(31) Andrews, J. L.; Santos, D. A.; Meyyappan, M.; Williams, R. S.; Banerjee, S. Building Brain-Inspired Logic Circuits from Dynamically Switchable Transition-Metal Oxides. Trends in Chemistry. Cell Press November 1, 2019, pp 711-726. https://doi.org/10.1016/j.trechm.2019.07.005.
(32) Wadsley, A. D. The Crystal Structure of Na 2-x V 6 O 15. Acta Crystallogr. 1955, 8 (11), 695-701. https://doi.org/10.1107/s0365110x55002144.
(33) Clites, M.; Pomerantseva, E. Stabilization of Battery Electrodes through Chemical Pre-Intercalation of Layered Materials. Low-Dimensional Mater. Devices 2016 2016, 9924 (September 2016), 992405. https://doi.org/10.1117/12.2238655.
(34) Chen, L.; Hao, C.; Zhang, Y.; Wei, Y.; Dai, L.; Cheng, J.; Zhang, H.; Ci, L. Guest Ions Pre-Intercalation Strategy of Manganese-Oxides for Supercapacitor and Battery Applications. J. Energy Chem. 2021, 60, 480-493. https://doi.org/10.1016/j.jechem.2021.01.023.
(35) Mitchell, J. B.; Geise, N. R.; Paterson, A. R.; Osti, N. C.; Sun, Y.; Fleischmann, S.; Zhang, R.; Madsen, L. A.; Toney, M. F.; Jiang, D. E.; Kolesnikov, A. I.; Mamontov, E.; Augustyn, V. Confined Interlayer Water Promotes Structural Stability for High-Rate Electrochemical Proton Intercalation in Tungsten Oxide Hydrates. ACS Energy Lett. 2019, 4 (12), 2805-2812. https://doi.org/10.1021/acsenergylett.9b02040.
(36) Pereira-Ramos, J. P.; Messina, R.; Znaidi, L.; Baffier, N. Electrochemical Lithium Intercalation in Na0.33V2O5 Bronze Prepared by Sol-Gel Processes. Solid State Ionics 1988, 28-30 (PART 1), 886-894. https://doi.org/10.1016/S0167-2738 (88) 80164-4.
(37) Bach, S.; Pereira-Ramos, J. P.; Baffier, N.; Messina, R. A Thermodynamic and Kinetic Study of Electrochemical Lithium Intercalation in Na0.33 V 2 O 5 Bronze Prepared by a Sol-Gel Process. J. Electrochem. Soc. 1990, 137 (4), 1042-1048. https://doi.org/10.1149/1.2086601.
(38) Baddour-Hadjean, R.; Bach, S.; Emery, N.; Pereira-Ramos, J. P. The Peculiar Structural Behaviour of β-Na0.33V 2O5 upon Electrochemical Lithium Insertion. J. Mater. Chem. 2011, 21 (30), 11296-11305. https://doi.org/10.1039/cljm11393c.
(39) Galy, J. Vanadium Pentoxide and Vanadium Oxide Bronzes-Structural Chemistry of Single(S) and Double (D) Layer MxV2O5 Phases. J. Solid State Chem. 1992, 100 (2), 229-245. https://doi.org/10.1016/0022-4596 (92) 90097-F.
(40) Kobayashi, H. Electrical Properties of a One-Dimensional Conductor, NaxV2O5. Bull. Chem. Soc. Jpn. 1979, 52 (5), 1315-1320. https://doi.org/10.1246/bcsj.52.1315.
(41) Galy, J.; Darriet, J.; Casalot, A.; Goodenough, J. B. Structure of the MxV2O and MxV2-YTO5 Phases. J. Solid State Chem. 1970, 1, 339-348.
(42) Krogstad, M. J.; Rosenkranz, S.; Wozniak, J. M.; Jennings, G.; Ruff, J. P. C.; Vaughey, J. T.; Osborn, R. Reciprocal Space Imaging of Ionic Correlations in Intercalation Compounds. Nat. Mater. 2020, 19 (1), 63-68. https://doi.org/10.1038/s41563-019-0500-7.
(43) Andrews, J. L.; Mukherjee, A.; Yoo, H. D.; Parija, A.; Marley, P. M.; Fakra, S.; Prendergast, D.; Cabana, J.; Klie, R. F.; Banerjee, S. Reversible Mg-Ion Insertion in a Metastable One-Dimensional Polymorph of V2O5. Chem 2018, 4 (3), 564-585. https://doi.org/10.1016/j.chempr.2017.12.018.
(44) Shannon, R. D. Revised Effective Ionic Radii and Systematic Studies of Interatomic Distances in Halides and Chalcogenides. Acta Crystallogr. Sect. A 1976, 32 (5), 751-767. https://doi.org/10.1107/S0567739476001551.
(45) Li, J.; Hwang, S.; Guo, F.; Li, S.; Chen, Z.; Kou, R.; Sun, K.; Sun, C. J.; Gan, H.; Yu, A.; Stach, E. A.; Zhou, H.; Su, D. Phase Evolution of Conversion-Type Electrode for Lithium Ion Batteries. Nat. Commun. 2019, 10 (1). https://doi.org/10.1038/s41467-019-09931-2.
(46) Varghese, B.; Reddy, M. V.; Yanwu, Z.; Lit, C. S.; Hoong, T. C.; Rao, G. V. S.; Chowdari, B. V. R.; Shen Wee, A. T.; Lim, C. T.; Sow, C. H. Fabrication of NiO Nanowall Electrodes for High Performance Lithium Ion Battery. Chem. Mater. 2008, 20 (10), 3360-3367. https://doi.org/10.1021/cm703512k.
(47) He, C.; Wu, S.; Zhao, N.; Shi, C.; Liu, E.; Li, J. Carbon-Encapsulated Fe304 Nanoparticles as a High-Rate Lithium Ion Battery Anode Material. ACS Nano 2013, 7 (5), 4459-4469. https://doi.org/10.1021/nn401059h.
(48) Wang, G.; Liu, H.; Liu, J.; Qiao, S.; Lu, G. M.; Munroe, P.; Ahn, H. Mesoporous LiFePO4/C Nanocomposite Cathode Materials for High Power Lithium Ion Batteries with Superior Performance. Adv. Mater. 2010, 22 (44), 4944-4948. https://doi.org/10.1002/adma.201002045.
(49) Luo, J. Y.; Wang, Y. G.; Xiong, H. M.; Xia, Y. Y. Ordered Mesoporous Spinel LiMn2O4 by a Soft-Chemical Process as a Cathode Material for Lithium-Ion Batteries. Chem. Mater. 2007, 19 (19), 4791-4795. https://doi.org/10.1021/cm0714180.
(50) Hu, J.; Jiang, Y.; Cui, S.; Duan, Y.; Liu, T.; Guo, H.; Lin, L.; Lin, Y.; Zheng, J.; Amine, K.; Pan, F. 3D Printed Cathodes of LiMn1−xFexPO4 Nanocrystals Achieve Both Ultrahigh Rate and High Capacity for Advanced Lithium-Ion Battery. Adv. Energy Mater. 2016, 6 (18). https://doi.org/10.1002/aenm.201600856.
(51) Handy, J. V.; Andrews, J. L.; Perez-Beltran, S.; Powell, D. R.; Albers, R.; Whittaker-Brooks, L.; Bhuvanesh, N.; Banerjee, S. A “Li-Eye” View of Diffusion Pathways in a 2D Intercalation Material from Topochemical Single-Crystal Transformation. ACS Energy Lett. 2022, 7, 1960-1962. https://doi.org/10.1021/ACSENERGYLETT.2C00739/SUPPL_FILE/NZ2C00739_SI_005.CIF.
(52) Handy, J. V.; Andrews, J. L.; Zhang, B.; Kim, D.; Bhuvanesh, N.; Tu, Q.; Qian, X.; Banerjee, S. Topochemical Stabilization and Single-Crystal Transformations of a Metastable 2D Γ′-V2O5 Intercalation Cathode. Cell Reports Phys. Sci. 2022, 100712. https://doi.org/10.1016/j.xcrp.2021.100712.
(53) Yamada, H.; Ueda, Y. Magnetic, Electric and Structural Properties of β-AxV 2O 5 (A=Na, Ag). http://dx.doi.org/10.1143/JPSJ.68.2735 2013, 68 (8), 2735-2740. https://doi.org/10.1143/JPSJ.68.2735.
(54) Chen, B.; Laverock, J.; Newby, D.; Su, T. Y.; Smith, K. E.; Wu, W.; Doerrer, L. H.; Quackenbush, N. F.; Sallis, S.; Piper, L. F. J.; et al. Electronic Structure of β-NaxV2O5 (x≈0.33) Polycrystalline Films: Growth, Spectroscopy, and Theory. J. Phys. Chem. C 2014, 118 (2), 1081-1094. https://doi.org/10.1021/JP410277M/ASSET/IMAGES/LARGE/JP-2013-10277M_0011.JPEG.
(55) Xu, Y.; Han, X.; Zheng, L.; Yan, W.; Xie, Y. Pillar Effect on Cyclability Enhancement for Aqueous Lithium Ion Batteries: A New Material of β-Vanadium Bronze M0.33V2O5 (M=Ag, Na) Nanowires. J. Mater. Chem. 2011, 21 (38), 14466-14472. https://doi.org/10.1039/cljm11910a.
(56) Rajendra, T.; Mistry, A. N.; Patel, P.; Ausderau, L. J.; Xiao, X.; Mukherjee, P. P.; Nelson, G. J. Quantifying Transport, Geometrical, and Morphological Parameters in Li-Ion Cathode Phases Using X-Ray Microtomography. ACS Appl. Mater. Interfaces 2019, 11 (22), 19933-19942. https://doi.org/10.1021/acsami.8b22758.
(57) Andrews, J. L.; Stein, P.; Santos, D. A.; Chalker, C. J.; De Jesus, L. R.; Davidson, R. D.; Gross, M. A.; Pharr, M.; Batteas, J. D.; Xu, B. X.; Banerjee, S. Curvature-Induced Modification of Mechano-Electrochemical Coupling and Nucleation Kinetics in a Cathode Material. Matter 2020, 3 (5), 1754-1773. https://doi.org/10.1016/j.matt.2020.08.030.
(58) Schulze, M. C.; Belson, R. M.; Kraynak, L. A.; Prieto, A. L. Electrodeposition of Sb/CNT Composite Films as Anodes for Li- and Na-Ion Batteries. Energy Storage Mater. 2020, 25 (September 2019), 572-584. https://doi.org/10.1016/j.ensm.2019.09.025.
(59) Parize, J. L.; Medouar, A.; Savariault, J. M.; Ballivet-Tkatchenko, D.; Galy, J. Formation of Sodium and Copper Vanadium Oxibronzes via Oxalate Decomposition: Thermal and X Ray Studies. Mater. Res. Bull. 1989, 24 (9), 1147-1153. https://doi.org/10.1016/0025-5408 (89) 90073-1.
(60) Wizansky, A. R.; Rauch, P. E.; Disalvo, F. J. Powerful Oxidizing Agents for the Oxidative Deintercalation of Lithium from Transition-Metal Oxides. J. Solid State Chem. 1989, 81 (2), 203-207. https://doi.org/10.1016/0022-4596 (89) 90007-8.
(61) Sheldrick, G. M.; IUCr. A Short History of SHELX. Acta Crystallogr. Sect. A Found. Crystallogr. 2008, 64 (1), 112-122. https://doi.org/10.1107/S0108767307043930.
(62) Hübschle, C. B.; Sheldrick, G. M.; Dittrich, B. ShelXle: A Qt Graphical User Interface for SHELXL. J. Appl. Crystallogr. 2011, 44 (6), 1281-1284. https://doi.org/10.1107/S0021889811043202.
(63) Wang, W.; Wang, H.; Liu, S.; Huang, J. Synthesis of γ-LiV 2O 5 Nanorods as a High-Performance Cathode for Li Ion Battery. J. Solid State Electrochem. 2012, 16 (7), 2555-2561. https://doi.org/10.1007/s10008-012-1659-x.
(64) Deng, Z.; Jiang, H.; Hu, Y.; Liu, Y.; Zhang, L.; Liu, H.; Li, C. 3D Ordered Macroporous MoS2@C Nanostructure for Flexible Li-Ion Batteries. Adv. Mater. 2017, 29 (10). https://doi.org/10.1002/adma.201603020.
(65) Borkiewicz, O. J.; Shyam, B.; Wiaderek, K. M.; Kurtz, C.; Chupas, P. J.; Chapman, K. W. The AMPIX Electrochemical Cell: A Versatile Apparatus for in Situ X-Ray Scattering and Spectroscopic Measurements. J. Appl. Crystallogr. 2012, 45 (6), 1261-1269. https://doi.org/10.1107/S0021889812042720.
(66) Toby, B. H.; Von Dreele, R. B. GSAS-II: The Genesis of a Modern Open-Source All Purpose Crystallography Software Package. J. Appl. Crystallogr. 2013, 46 (2), 544-549. https://doi.org/10.1107/S0021889813003531.
(67) Henkelman, G.; Jónsson, H. Improved Tangent Estimate in the Nudged Elastic Band Method for Finding Minimum Energy Paths and Saddle Points. J. Chem. Phys. 2000, 113 (22), 9978-9985. https://doi.org/10.1063/1.1323224.
(68) Hohenberg, P.; Kohn, W. Inhomogeneous Electron Gas. Phys. Rev. 1964, 136 (3B), B864-B871. https://doi.org/10.1103/PhysRev.136.B864.
(69) Kohn, W.; Sham, L. J. Self-Consistent Equations Including Exchange and Correlation Effects. Phys. Rev. 1965, 140 (4A). https://doi.org/10.1103/PhysRev.140.A1133.
(70) Kresse, G.; Furthmüller, J. Efficient Iterative Schemes for Ab Initio Total-Energy Calculations Using a Plane-Wave Basis Set. Phys. Rev. B 1996, 54 (16), 11169-11186. https://doi.org/10.1103/PhysRevB.54.11169.
(71) Blöchl, P. E. Projector Augmented-Wave Method. Phys. Rev. B 1994, 50 (24), 17953-17979. https://doi.org/10.1103/PhysRevB.50.17953.
(72) Perdew, J. P.; Burke, K.; Ernzerhof, M. Generalized Gradient Approximation Made Simple. Phys. Rev. Lett. 1996, 77 (18), 3865-3868. https://doi.org/10.1103/PhysRevLett.77.3865.
(73) Monkhorst, H. J.; Pack, J. D. Special Points for Brillouin-Zone Integrations. Phys. Rev. B 1976, 13 (12), 5188-5192. https://doi.org/10.1103/PhysRevB.13.5188.

1-25. (canceled)

26. A cathode material comprising preintercalated β-NaₓV₂O₅ and/or β-K_{y}V₂O₅, where x is about 0.20 to about 0.34 and y is about 0.22 to about 0.33, said β-NaₓV₂O₅ being preintercalated with sodium ions and said β-K_{y}V₂O₅ being preintercalated with potassium ions.

27. The cathode material according to claim 26, wherein x is about 0.32 and y is about 0.22.

28. The cathode material according to claim 26, wherein said cathode material comprises preintercalated β-NaₓV₂O₅, where x is about 0.22 to about 0.28 or is about 0.25; or wherein said cathode material comprises preintercalated β-K_{y}V₂O₅, where y is about 0.22 to about 0.33 or is about 0.27.

29. The cathode material according to claim 26, wherein said cathode material comprises β-NaₓV₂O₅, having lattice constants comprising:
a) a=15.409 (8) Å, b=3.609 (1) Å, and c=10.780 (9) Å for x=0.25; or
b) a=15.3629 (7) Å, b=3.6109 (2) Å, and c=10.0502 (5) Å for x=0.32; or wherein said cathode material comprises β-K_{y}V₂O₅, having lattice constants comprising:
c) a=15.60 (2) Å, b=3.612 (1) Å, and c=10.093 (9) Å for y=0.27; or
d) a=15.4753 (10) Å, b=3.6123 (2) Å, and c=10.0693 (6) Å for y=0.22.

30. The cathode material according to claim 26, said cathode material being intercalated with an ion selected from the group consisting of Li⁺ ions, Na⁺ ions, Al³⁺ ions, Y³⁺ ions, Ca²⁺ ions, Mg²⁺ ions, Zn²⁺ ions, and combinations thereof.

31. The cathode material according to claim 26, wherein the cathode comprises β-K_{0.27}V₂O₅ having a unit cell volume of 537.085 Å³, or the cathode comprises β-Na_{0.25} V₂O₅ having a unit cell volume of 528.168 Å³.

32. A cathode material comprising β-Na_{0.32}/β′-Li_{0.33} V₂O₅, said cathode material having a unit cell volume of 530.32 (3) Å³ and lattice constants comprising: a=10.1482 (3) Å, b=3.6308 (1) Å, and c=15.2420 (4) Å.

33. A battery comprising a cathode material according to claim 26.

34. The battery according to claim 33, wherein the battery is a Li-ion battery, a Li battery, a Mg-ion battery or a Mg battery.

35. The battery according to claim 33, wherein the cathode further comprises a conductive agent and a polymeric binder and an anode comprising an anode material selected from the group consisting of activated carbon cloth, graphite, Li metal, a Li alloy, an intermetallic compound containing Li, Mg metal, a Mg alloy containing Mg, and an intermetallic compound containing Mg.

36. A method of making preintercalated β-NaₓV₂O₅ where x is about 0.20 to about 0.34 comprising: reacting V₂O₅ and oxalic acid in water and heating the mixture to a temperature of between about 60° C. and about 100° C. and adding sodium nitrate to said mixture of V₂O₅ and oxalic acid.

37. The method according to claim 36, said method further comprising stirring the mixture and, optionally, continued heating of the mixture until free water is evaporated and a powder is obtained.

38. The method according to claim 37, said method further comprising grinding the powder.

39. The method according to claim 38, said method further comprising annealing the powder in a furnace at a temperature of about 350° C. to about 550° C. or at a temperature of about 450° C. for a period of about 3 to about 9 hours.

40. The method according to claim 36, wherein x is 0.25 or 0.32.

41. The method according to claim 36, said method further comprising intercalating said preintercalated β-NaₓV₂O₅ or said preintercalated β-K_{y}V₂O₅ with an ion selected from the group consisting of Li⁺ ions, Na⁺ ions, Al³⁺ ions, Y³⁺ ions, Ca²⁺ ions, Mg²⁺ ions, Zn²⁺ ions, and combinations thereof.

42. A method of making preintercalated β-K_{y}V₂O₅, where y is about 0.20 to about 0.33 comprising: reacting V₂O₅ and oxalic acid in water and heating the mixture to a temperature of between about 60° C. and about 100° C. and adding potassium nitrate to said mixture of V₂O₅ and oxalic acid.

43. The method according to claim 42, said method further comprising stirring the mixture and, optionally, continued heating of the mixture until free water is evaporated and a powder is obtained.

44. The method according to claim 42, said method further comprising intercalating said preintercalated β-NaₓV₂O₅ or said preintercalated β-K_{y}V₂O₅ with an ion selected from the group consisting of Lit ions, Na⁺ ions, Al³⁺ ions, Y³⁺ ions, Ca²⁺ ions, Mg²⁺ ions, Zn²⁺ ions, and combinations thereof.

45. A battery comprising a cathode material according to claim 32.
